(19) United States
(12) Patent Application Publication
(10) Pub. No.: US 2017/0366652 A1
(43) Pub. Date: Dec. 21, 2017

(54) Cell Phone Accessory Apparatus and System With Camera Functionality

(71) Applicant: Eyes On Scope, LLC, Bethpage, NY (US)

(72) Inventor: Scott E. Boerckel, Dix Hills, NY (US)

(73) Assignee: Eyes On Scope, LLC, Bethpage, NY (US)

(21) Appl. No.: 15/667,365

(22) Filed: Aug. 2, 2017

Related U.S. Application Data
(63) Continuation-in-part of application No. 15/184,654, filed on Jun. 16, 2016.

(51) Int. Cl. H04M 1/02; H04N 5/225; H04B 1/3888

(52) U.S. Cl. CPC H04M 1/0264; H04B 1/3888; H04N 5/2253

(57) ABSTRACT

An accessory device for use in conjunction with an electronic device (e.g., a smartphone, tablet or the like) is provided that incorporates an extendable camera that interacts with the electronic device to deliver still and/or moving images. The accessory device is adapted to be mounted with respect to the portable electronic device and to facilitate communication between the camera and the processing unit associated with the electronic device. The accessory device includes a rotatable dial that allows rotation of the extendable camera from a non-deployed axial orientation to a deployed axial orientation.

### CROSS-REFERENCE TO RELATED APPLICATION

The present application is a continuation-in-part application that claims priority benefit to a co-pending non-provisional application entitled “I-Scope Cell Phone Case Providing Functionality,” which was filed on Jun. 16, 2016 and assigned Ser. No. 15/184,654. The entire content of the foregoing non-provisional application is incorporated herein by reference.

### FIELD OF DISCLOSURE

The present disclosure provides an advantageous “smart case” for a portable electronic device (e.g., smartphone, tablet, and the like) that incorporates into the case an extendable camera that interacts with the electronic device to deliver still and/or moving images. The smart case is adapted to be mounted with respect to the portable electronic device and to facilitate communication between the camera and the processing unit associated with the electronic device. The present disclosure further provides a subassembly that is adapted to be mounted with respect to an electronic device and/or a case for an electronic device, the subassembly including an extendable camera to deliver still and/or moving images.

### BACKGROUND

With the growth of smartphones and tablets, there has been a concurrent growth in consumer expectations concerning, inter alia, compactness, speed and functionality of electronic devices. Users rely on their smartphones/tablets for a variety of tasks; however, a task common is the ability to capture and communicate high quality/resolution pictures and videos with our smartphones/tablets. While smartphones/tablets have made capturing pictures and videos significantly less onerous, simply by eliminating the need to carry an additional camera, there are pitfalls and limitations associated with current smartphone/tablet camera designs and their utilities.

For example, the inability to easily capture pictures/videos of oneself surrounded by a group of peers, commonly referred to as a “group selfie,” and the inability to capture pictures/videos of desired individuals/activities, e.g., entertainers/dignitaries at crowded events (e.g., a concert, a public speech, a sporting event, and the like) are significant shortcomings. In the latter case, the issue is most pronounced when the smartphone/tablet user is on equal footing with others in a crowded area. Common to both noted issues/shortcomings is the necessity for the user to vertically extend his/her arms in order to capture a desired picture/video, thereby potentially producing a blurry or fragmented picture/video and possibly obstructing the view of others. Monopods, commonly referred to as “selfie sticks,” have become increasingly popular in an attempt to overcome these difficulties; however, selfie sticks extend the entire smartphone/tablet away from the user, thereby making it cumbersome and more difficult to control and view an image prior to its capture.

The patent literature discloses designs that include electronic devices that include integrated extendable cameras, see U.S. Pat. No. 8,224,179 and U.S. Publication Number 2015/0281525. However, as the cost of smartphones/tablets continues to rise, consumers may be less likely to purchase a new smartphone/tablet for every novel feature that is integrated into those products. In addition, users may desire flexibility as to when the additional functionality of an extendable camera is desired. Still further, integration of the noted camera functionality with a specific electronic device necessarily limits its use to that specific device.

Therefore, despite efforts in the industry to enhance functionalities associated with the capture of images (both still and moving), the pitfalls and limitations highlighted above remain. The devices, systems and methods of the present application address the noted shortcomings/limitations.

### SUMMARY

The present disclosure provides advantageous “smart case” designs/assemblies for use with portable electronic devices (e.g., smartphones, tablets, and the like). The smart case designs/assemblies advantageously incorporate an extendable camera that interacts with the electronic device to deliver still and/or moving images. The smart case is generally adapted to be mounted with respect to the portable electronic device and to facilitate communication between the camera and the processing unit associated with the electronic device. Exemplary smart case designs/assemblies according to the present disclosure may also include a pivotal stand that is mounted with respect to the design/assembly, and that permits the smart case/electronic device combination to be positioned in a substantially upright position without user interaction.

The extendable camera is generally mounted with respect to a telescoping arm that is adapted to collapse, i.e., assume a non-telescoping orientation, for camera storage purposes. Thus, the disclosed smart case may advantageously define an extension, e.g., a substantially rectangular extension, that is configured and dimensioned to receive the telescoping arm in a non-telescoped orientation, and to house/secure the camera in a fixed and protected position. In exemplary embodiments, the pivotal stand defines a substantially U-shaped geometry and is movably mounted with respect to the extension. The pivotal stand may be adapted to pivot into a substantially flush orientation with the smart case, such “flush orientation” placing the U-shaped stand around the substantially rectangular extension.

The extension may define an exposed slot that is adapted to receive an outwardly extending feature, e.g., a button, associated with the camera. Interaction between the slot and the outwardly extending feature may advantageously function to align and secure the camera when in the collapsed/non-extended orientation. When the user desires to extend the camera (and telescope the extension arm), the outwardly extending feature may be slid upward relative to the slot to free the camera from the extension.

Once extended, the camera is generally free to rotate around multiple axes relative to the telescoping extension arm. In exemplary embodiments, the telescoping extension arm also exhibits rotational freedom of movement relative to the smart case housing, e.g., a pivotal freedom of movement, thereby further enhancing the flexibility in camera positioning permitted by the disclosed devices/assemblies.

The camera units associated with the designs/assemblies of the present disclosure advantageously communicate with the processing unit associated with an electrical device to which it is synched. Thus, for example, the camera unit associated with the disclosed smart case may wirelessly communicate with the processing unit associated with the smart phone/tablet or other electronic device to which the smart case is mounted, thereby receiving prompts/commands from the smart phone/tablet or other electronic device, and communicating images captured by the camera unit to the processing unit. The wireless communication may be accomplished by any communication modality, e.g., Blue Tooth communication. In alternative embodiments, a “wired” communication modality may be employed, whereby the disclosed camera unit communicates by way of a cable to a jack associated with the electronic device, thereby receiving/delivering electronic communications to the processing unit in a conventional wired manner. Of note, the power required to drive the camera unit's functionalities, including communication of images to a processing unit associated with the electronic device, may be provided by a conventional battery, a solar energy source, or through energy transfer from the electronic device, whether on an ongoing basis or based on periodic charges.

The present disclosure further provides a subassembly that is adapted to be mounted with respect to an electronic device and/or a case for an electronic device, the subassembly including an extendable camera to deliver still and/or moving images. Thus, the disclosed subassembly may define a self-contained unit that includes a telescoping extension arm and camera unit, together with a means/mechanism for adhering or otherwise mounting the subassembly relative to an electronic device and/or case for an electronic device. Once adhered/mounted with respect to an electronic device and/or a case for an electronic device (that is, in turn, mounted with respect to an electronic device), the disclosed subassembly provides advantageous features and functions of the type disclosed herein with respect to the smart case with integrated extension arm/camera.

In further exemplary embodiments, the present disclosure provides an accessory device for use with an electronic device. The accessory device may advantageously include (i) a housing that defines a housing axis and that is configured and dimensioned to be mounted with respect to the electronic device, (ii) a rotatable dial rotatably mounted with respect to the housing, (iii) a telescoping extension arm that defines an extension arm axis and that is mounted with respect to the rotatable dial, and (iv) a camera mounted with respect to a distal end of the telescoping extension arm. The rotatable dial permits the extension arm axis of the telescoping extension arm to rotate at least 180° relative to the housing axis. The camera is adapted for electronic communication with the electronic device to deliver one or more images captured by the camera to the electronic device. The housing is generally detachably mounted with respect to the electronic device.

One or more magnetic elements may be positioned within the housing that function to detachably mount the housing with respect to the electronic device. A kickstand may be pivotally or rotatably mounted with respect to the housing. The camera is generally mounted with respect to the distal end of the extension arm by way of a swivel joint. The camera may thus be angularly repositioned relative to the extension arm relative to both the x-axis and the y-axis.

Means for communication is generally provided such that commands from the electronic device may be received by the accessory device from the electronic device, and images may be communicated from the camera to the electronic device.

The telescoping extension arm generally includes a telescoping extension and one or more nested telescoping extensions. The rotatable dial is generally mounted with respect to an upward extension tab defined by the housing.

In still further embodiments of the present disclosure, a combination is provided that includes (i) an electronic device; and (ii) an accessory device detachably mounted with respect to the electronic device. The accessory device generally includes (i) a housing that defines a housing axis and that is configured and dimensioned to be mounted with respect to the electronic device, (ii) a rotatable dial rotatably mounted with respect to the housing, (iii) a telescoping extension arm that defines an extension arm axis and that is mounted with respect to the rotatable dial, and (iv) a camera mounted with respect to a distal end of the telescoping extension arm. The rotatable dial generally permits the extension arm axis of the telescoping extension arm to rotate at least 180° relative to the housing axis. The camera is adapted for electronic communication with the electronic device to deliver one or more images captured by the camera to the electronic device. The electronic device is generally a smartphone, tablet or other electronic device with similar capabilities.

The electronic device may communicate with the accessory device by a wired connection or wirelessly. The electronic device may be used to actuate the camera of the accessory device.

Additional advantageous features, functions and benefits associated with the devices, systems and methods of the present disclosure will be apparent from the description which follows, particularly when read in conjunction with the appended figures.

### BRIEF DESCRIPTION OF FIGURES

A more complete understanding of the present disclosure and advantages thereof may be acquired by referring to the following description in consideration with the accompanying drawings, in which like reference numbers indicate like features.

FIG. 1 is a back perspective view of an exemplary case for use with an electronic device according to the present disclosure.

FIG. 2 is a front perspective view of the exemplary case for use with an electronic device according to the present disclosure.

FIG. 3 is a front perspective view of the exemplary case for use with an electronic device with an associated stand extended.

FIG. 4 is a back perspective view of an exemplary case for use with an electronic device with the associated stand extended.

FIG. 5 is a front perspective view of an exemplary case for use with an electronic device in operation/use with the integrated camera extended and angled, according to the present disclosure.

FIG. 6 is a back perspective view of an exemplary case for use with an electronic device in operation/use with the integrated camera extended and angled, according to the present disclosure.

FIG. 7 is an exploded view of a cell phone interfacing with an exemplary case with advantageous camera functionality according to the present disclosure.

FIG. 8 is a back view of an exemplary case for use with an electronic device according to the present disclosure.

FIG. 9 a front view of an exemplary case for use with an electronic device according to the present disclosure.

FIG. 10 is a side view of an exemplary case for use with an electronic device according to the present disclosure.

FIG. 11 is a side view of an exemplary case for use with an electronic device according to the present disclosure.

FIG. 12 is a top view of an exemplary case for use with an electronic device according to the present disclosure.

FIG. 13 is a bottom view of an exemplary case for use with an electronic device according to the present disclosure.

FIG. 14 is a front view of exemplary case for use with an electronic device according to the present disclosure.

FIG. 15 is a section view of an exemplary case for use with an electronic device showing an exemplary telescoping camera assembly according to the present disclosure.

FIG. 16 is a back perspective view of an exemplary case for use with an electronic device with the stand extended, according to the present disclosure.

FIG. 17 is a side view of an exemplary case for use with an electronic device with the stand extended, according to the present disclosure.

FIG. 18 is a back view of an exemplary case for use with an electronic device with the camera partially extended, according to the present disclosure.

FIG. 19 is a side view of an exemplary case for use with an electronic device with the camera partially extended, according to the present disclosure.

FIG. 20 is a back perspective view of an exemplary case for use with an electronic device with the camera partially extended, according to the present disclosure.

FIG. 21 is a back perspective view of an exemplary case for use with an electronic device with the camera angled and partially extended, according to the present disclosure.

FIG. 22 is a side view of an exemplary case for use with an electronic device with the camera angled and partially extended, according to the present disclosure.

FIG. 23 is a back view of an exemplary case for use with an electronic device with the camera angled and partially extended, according to the present disclosure.

FIG. 24 is a side view, partially in phantom, of an exemplary case for use with an electronic device showing an extended camera without an angle and an extended camera with an angle, according to the present disclosure.

FIG. 25 is a back perspective view, partially in phantom, of an exemplary case for use with an electronic device showing an extended camera without an angle and an extended camera with an angle, according to the present disclosure.

FIG. 26 is a back view, partially in phantom, of an exemplary case for use with an electronic device showing an extended camera without an angle and an extended camera with an angle, according to the present disclosure.

FIG. 27 is a front perspective view of an exemplary case for use with an electronic device with the exemplary camera angled and partially extended, according to the present disclosure.

FIG. 28 is a side view of an exemplary case for use with an electronic device with the camera angled and partially extended, according to the present disclosure.

FIG. 29 is a front perspective view of an exemplary case for use with an electronic device with the camera angled and the telescoping mechanism segmented to show full extension of the camera, according to the present disclosure.

FIG. 30 is a side view of an exemplary case for use with an electronic device with the camera angled and the telescoping mechanism segmented to show full extension of the camera, according to the present disclosure.

FIG. 31 is an exploded view of an exemplary case for use with an electronic device according to the present disclosure.

FIG. 32 is a front perspective view of an exemplary case for use with an electronic device in operation/use with the integrated camera extended and angled towards the user, according to the present disclosure.

FIG. 33 is a front view of a standalone camera according to the present disclosure.

FIG. 34 is an exploded view of an exemplary camera attachment according to the present disclosure.

FIG. 35 is a back perspective view of an exemplary camera attachment according to the present disclosure.

FIG. 36 is a back perspective view of an exemplary camera attachment according to the present disclosure.

FIG. 37 is an exploded view of an exemplary camera attachment interfacing with an electronic device, according to the present disclosure.

FIG. 38 is a back view of an exemplary camera attachment affixed to the back of an electronic device, according to the present disclosure.

FIG. 39 is a back perspective view of an exemplary camera attachment affixed to the back of an electronic device, according to the present disclosure.

FIG. 40 is a front perspective view of the camera attached to the extension arm in a non-angled position, according to the present disclosure.

FIG. 41 is a front perspective view of the camera attached to the extension arm in a forward tilted position, according to the present disclosure.

FIG. 42 is a front perspective view of the camera attached to the extension arm in a sideways tilted position, according to the present disclosure.

FIG. 43 is a back perspective view of an exemplary camera attachment in operation/use with the camera vertically extended, according to the present disclosure.

FIG. 44 is a back view of an exemplary camera attachment in operation/use with the camera vertically extended, according to the present disclosure.

FIG. 45 is a back perspective view of an exemplary camera attachment in operation/use with the camera extended and angled, according to the present disclosure.

FIG. 46 is a front view of the camera vertically extended, according to the present disclosure.

FIG. 47 is a front perspective view of an exemplary camera attachment in operation/use with the camera extended and angled, according to the present disclosure.

FIG. 48 is a back perspective view of an exemplary camera attachment with a connector that will interface with an electronic device, according to the present disclosure.

FIG. 49 is a back view of an exemplary camera attachment with a connector that will interface with an electronic device, according to the present disclosure.

FIG. 50 is a back view of an exemplary camera attachment with a connector interfaced with an electronic device, according to the present disclosure.

FIG. 51 is a front perspective view of an alternative camera attachment accessory in a non-deployed configuration according to the present disclosure.

FIG. 52 is a rear view of the alternative camera attachment accessory of FIG. 51.

FIG. 53 is a first side view of the alternative camera attachment accessory of FIG. 51 (from the side on which the kickstand is mounted).

FIG. 54 is a front view of the alternative camera attachment accessory of FIG. 51.

FIG. 55 a second side view of the alternative camera attachment accessory of FIG. 51 (from the side opposite the one on which the kickstand is mounted).

FIG. 56 is a top view of the alternative camera attachment accessory of FIG. 51.

FIG. 57 is a bottom view of the alternative camera attachment accessory of FIG. 51.

FIG. 58 is a further front view of the alternative camera attachment accessory of FIG. 51 (showing the plane in which the cross-section of FIG. 59 is taken).

FIG. 59 is a cross-section of the alternative camera attachment accessory of FIG. 51 taken along the A-A line shown in FIG. 58.

FIG. 60 is an exploded view of the alternative camera attachment accessory of FIG. 51.

FIG. 61 is a perspective rear view of the alternative camera attachment accessory of FIG. 51 secured to a smartphone and showing the kickstand deployed to support the smartphone in a substantially upright orientation.

FIG. 62 is a side view of the alternative camera attachment accessory of FIG. 51 secured to a smartphone and showing the kickstand deployed to support the smartphone in a substantially upright orientation., showing the kickstand deployed.

FIG. 63 is a perspective view of the alternative camera attachment accessory of FIG. 51 secured to a smartphone and showing the camera associated with the camera attachment accessory extended therefrom.

FIGS. 64-66 show wired communication between the accessory device and the electronic device according to an exemplary embodiment of the present disclosure.

FIGS. 67 and 68 show reorientation of the camera relative to the extension arm according to an exemplary embodiment of the present disclosure.

FIGS. 69 and 70 show the telescoping functionality of the accessory device according to an exemplary embodiment of the present disclosure.

### DESCRIPTION OF EXEMPLARY EMBODIMENT(S)

The present application relates generally to a “smart case” designed as an accessory for smartphones, tablets and other electronic devices that includes, inter alia, an extendable and adjustable camera that is wirelessly and/or physically connected to and in communication with the smartphone/tablet or other electronic device to communicate images captured by the camera. The smartphone depicted throughout the figures is an iPhone 6®—a product of Apple Inc.; however, the disclosed smart case can be designed to fit any smartphone/tablet model or other electronic device, as will be readily apparent to persons skilled in the art, and the iPhone® depicted throughout the present disclosure is merely an example to illustrate the features and functions of the disclosed smart case. With regards to this application, the terms smartphone and tablet are used interchangeably.

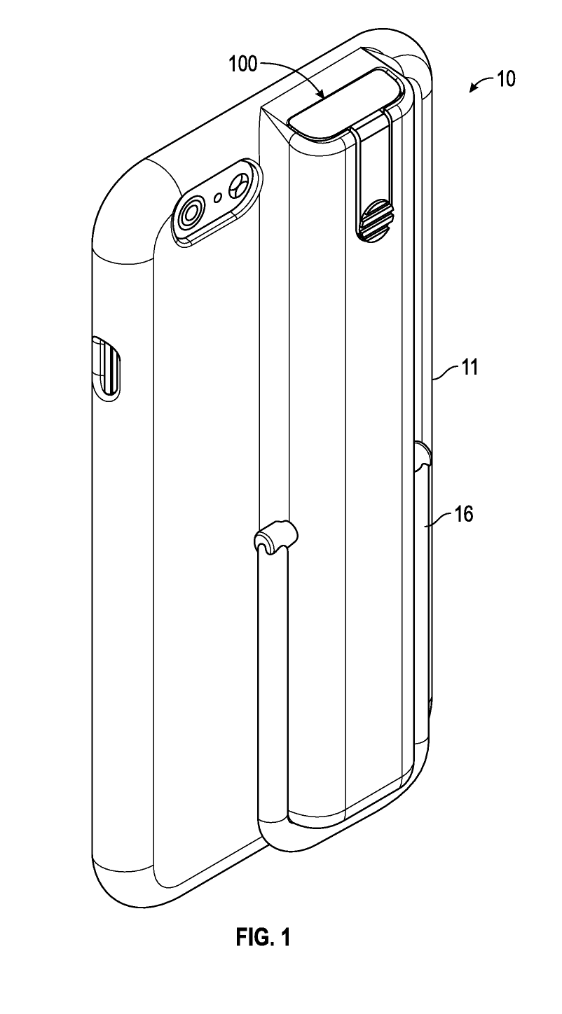

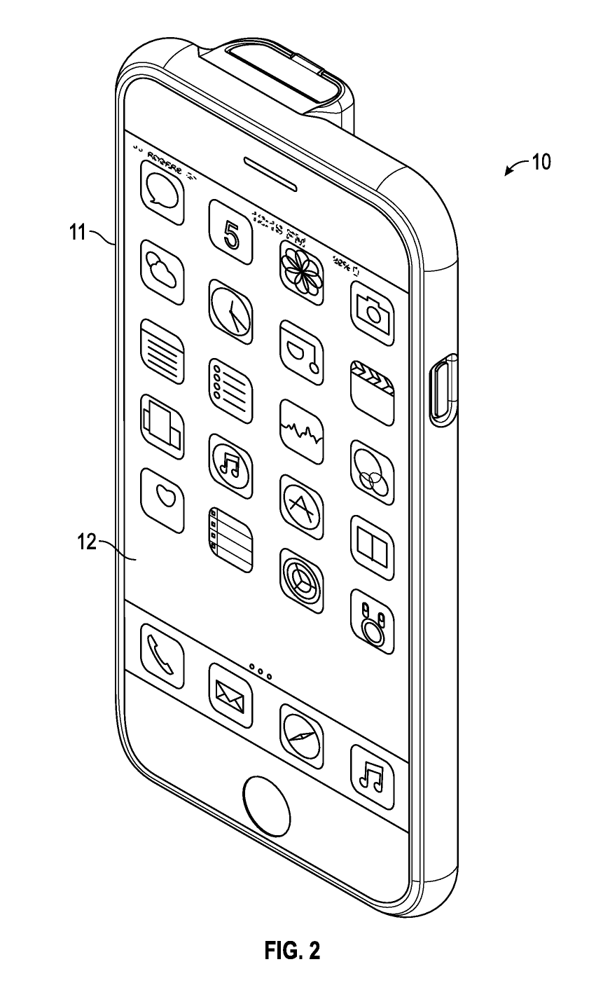

FIGS. 1 and 2 illustrate an exemplary smart case assembly 10 according to the present disclosure, wherein smart case 11 is mounted with respect to a conventional smartphone 12. Although the smart case 11 may be mounted with respect to smartphone 12 (or other electronic devices) in various ways, FIGS. 1 and 2 illustrate an implementation wherein the smart case 11 defines a substantially rectangular cavity region that is configured and dimensioned to receive the smartphone 12. Alternative mounting mechanisms and/or techniques may be employed, as will be readily apparent to persons skilled in the art. For example, the smart case 11 may be adhered with respect to smartphone 12 (or other electronic device) using conventional adhesives, as are known in the art. The present disclosure is not limited by or to the manner of mounting the disclosed smart case relative to an associated electronic device.

The exemplary smart case assembly 10 includes a stand mechanism 16 and a camera assembly 100, which are depicted in a collapsed or non-deployed position. The stand mechanism 16 is pivotally mounted with respect to the back wall of smart case 11 and is adapted to assume a substantially flush orientation relative to the rear wall 26 of smart case 11 when in a non-pivoted orientation. The pivotal connection may be achieved by horizontal pin-link members that are adapted to be received in receiving apertures defined in the housing of the smart case 11, although alternative pivotal connection mechanisms may be employed. The illustrated stand mechanism 16 defines a substantially U-shaped geometry, although alternative geometries may be employed. The pivotal connection of the stand mechanism 16 relative to the back wall of the smart case 11 generally limits the degree to which the stand mechanism 16 may pivot relative to the smart case, e.g., 30° relative to the vertical axis defined by an upright smartphone 12, although an alternative angular range of motion may be employed (as well as a plurality of predefined angular “stops” that may be “clicked through” by the user to arrive at a desired smartphone position). With the moveable features (i.e., stand mechanism 16 and camera assembly 100) in their collapsed positions, the smartphone 12 and smart case assembly 10 define their “smallest” or most compact configuration, and may be placed into a pants pocket, a purse and the like without fear of damaging the camera assembly 100 and/or the stand mechanism 16.

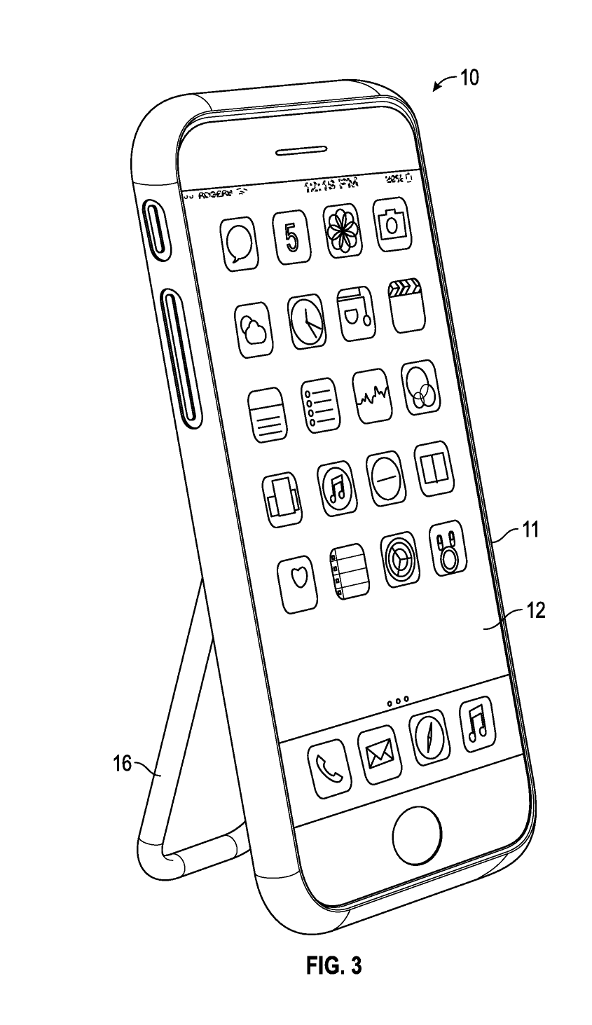

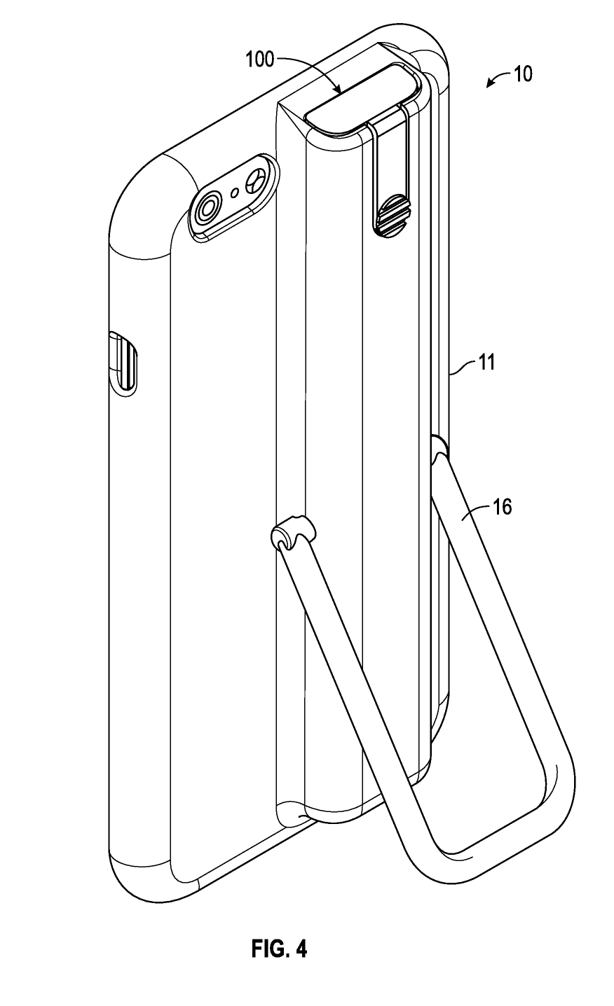

FIGS. 3 and 4 illustrate a smart case assembly 10 wherein the smart case 11 is mounted around a smartphone 12. The stand mechanism 16 is pivoted away from the back of the smart case 11 and, when placed on a surface, the smart case assembly 10 assumes an angled position that is suitable for viewing/interacting with the smartphone 12 and/or utilizing the extendable camera assembly 100.

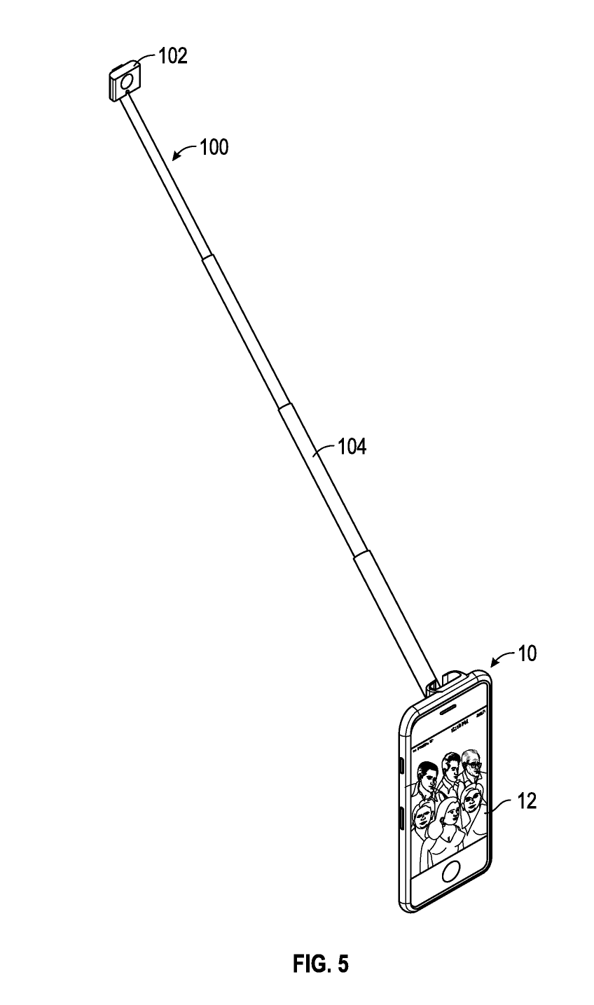

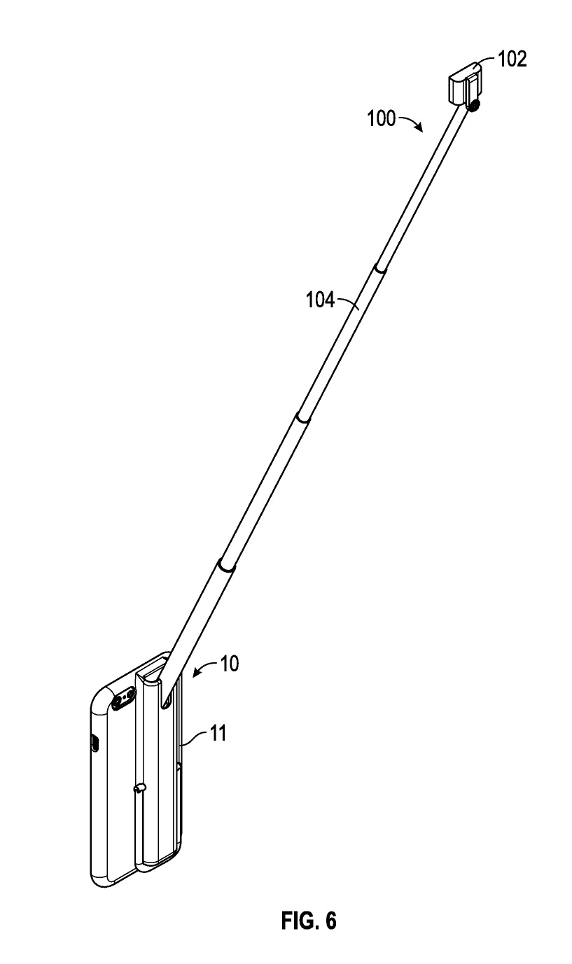

FIGS. 5 and 6 illustrate a smart case assembly 10 associated with smartphone 12, wherein the camera assembly 100 is extended and angled based on the user's preferences. More specifically, camera assembly 100 includes a telescoping extension arm 104 that is adapted to extend away from the housing of smart case 11 so as to position the camera 102—which is mounted at or adjacent a distal end of the extension arm 104—away from the smartphone 12. Of note, the camera 102 is generally mounted with respect to the extension arm 104 by way of a “swivel joint,” such that the camera 102 may be angularly repositioned relative to the extension arm 104 relative to both the x-axis and the y-axis. Still further, the proximal end of the extension arm 104 is generally mounted with respect to the housing of smart case 11 so as to accommodate angular adjustments relative to the x-axis and the y-axis, thereby accommodating substantial angular adjustment to the positioning of the camera 102 relative to the housing of the smart case 11 (and therefore relative to the smartphone 12). This flexibility in angular orientation of the camera 102 allows the user to capture desired images over a wide range of relative positions and orientations.

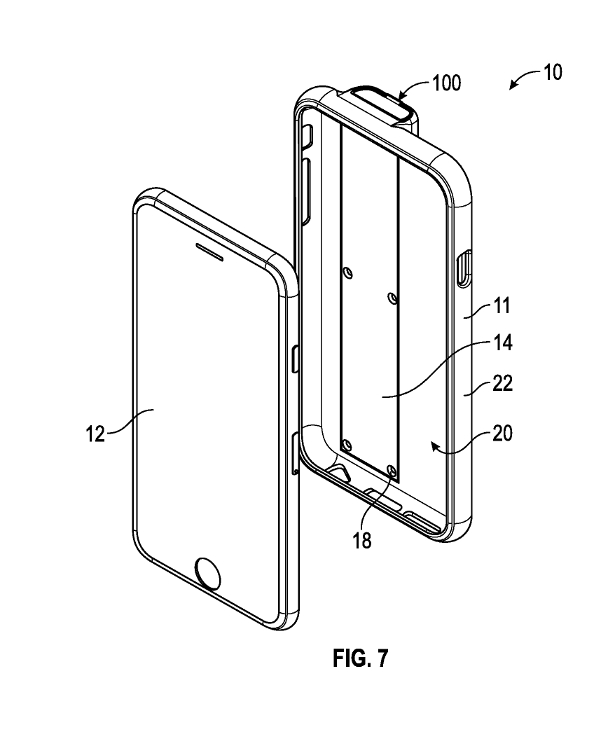

FIG. 7 illustrates a smartphone 12 interfacing with an exemplary smart case 11 according to the present disclosure, wherein the smart case 11 is configured and dimensioned designed to accommodate smartphone 12 within a substantially rectangular interior region 20 defined by an outer wall 22 that extends around the perimeter thereof. The interior design features of the smart case 11 are generally designed to mirror the exterior design features of the smartphone 12 (i.e., the interior region 20 includes radiused edges, a depth, a width, and a height that accommodate the smartphone 12), thereby producing a tight fit around the smartphone 12. Furthermore, the smart case 11 provides access to any ports, buttons/toggles or speakers located on the exterior of the smartphone 12.

FIG. 7 shows an internal cover 14 associated with smart case 11. Cover 14 is generally removably mounted with respect to the back wall of smart case 11, e.g., for assembly and/or maintenance purposes, and is substantially flush with the back wall of smart case 11 so as to avoid any interference with the smart phone 12 when mounted with respect thereto. FIG. 7 shows the camera assembly 100 in a collapsed position and its movable components, including the telescoping arm and the camera (not shown), hidden within a cavity that is configured and dimensioned to receive the extension arm 104 in its non-telescoped orientation as well as the camera 102. These components are on the opposite side of internal cover 14. The cover 14 can be affixed to the case 11 via a snap-like connection, screws 18 or another installation method known to a person skilled in the art.

The smart case 11 can be fabricated from various materials, as is known in the art. For example, the smart case 11 may be fabricated, in whole or in part, from a flexible material, for example, rubber, or a firmer material, for example plastic, whereby the edges of the flexible material can be expanded to insert the smartphone 12. Meanwhile, the firmer material may require a two-piece construction to fit around the smartphone, wherein the two pieces can snap together to create the illusion of a single piece construction.

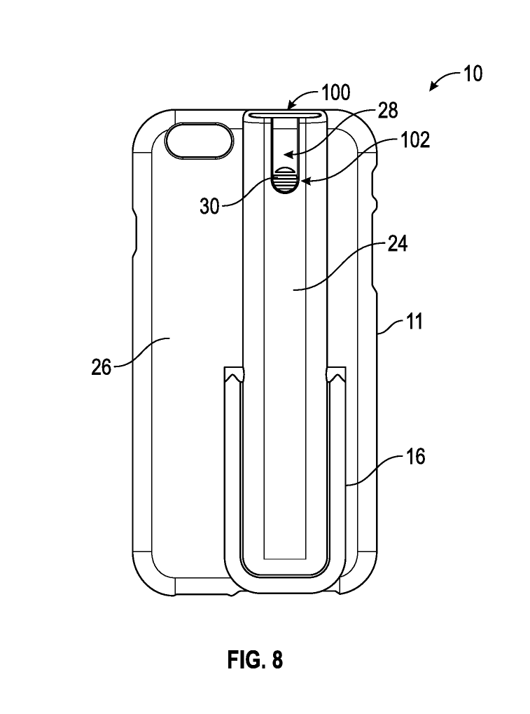

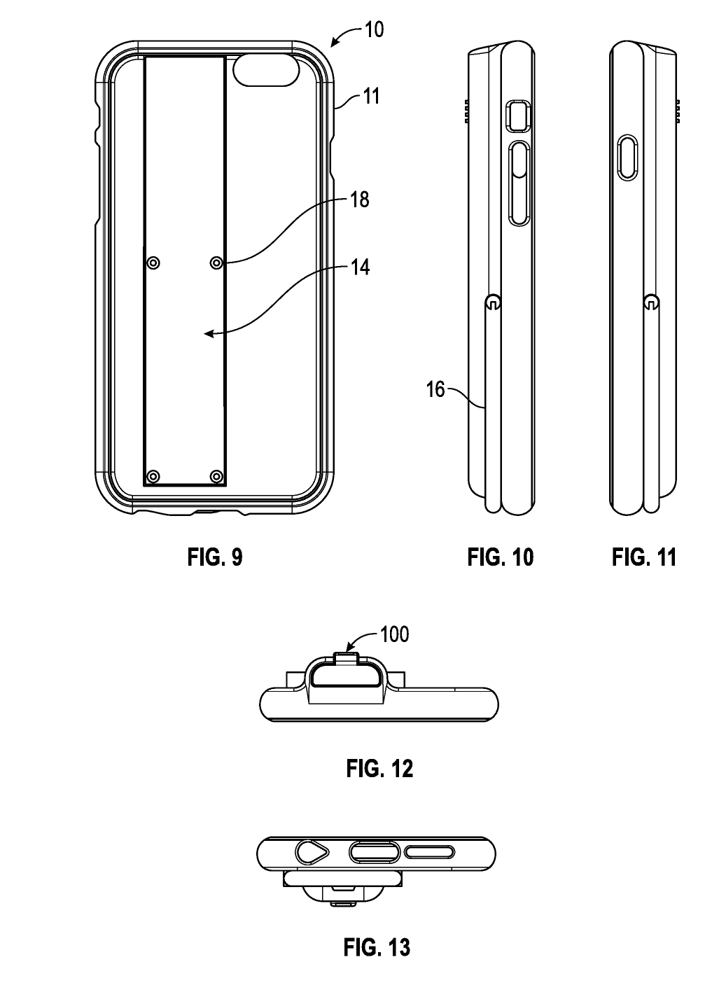

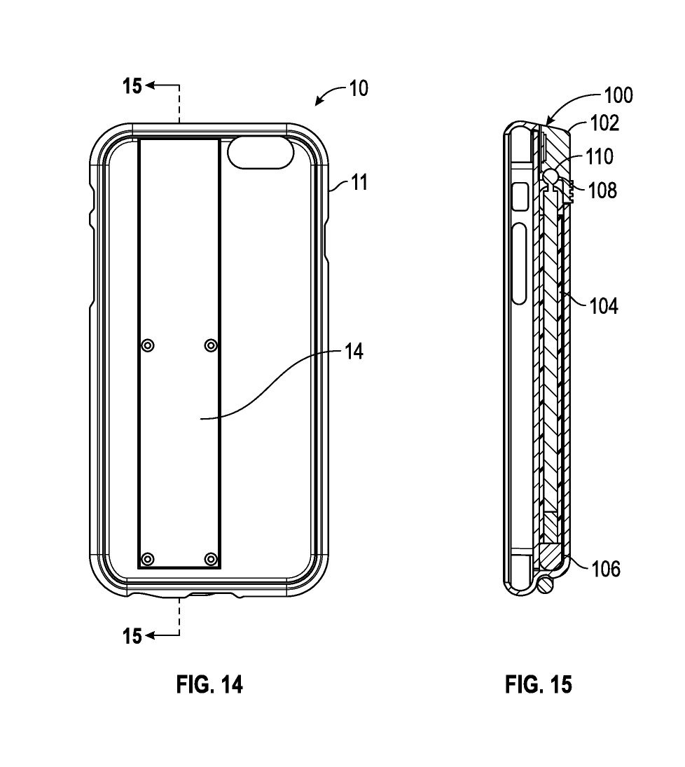

Turning to FIGS. 8-15, a set of views of exemplary smart case 11 are provided, which illustrate exemplary features/functions associated with the design and operation of the extendable camera functionality. In particular, the smart case 11 defines a substantially rectangular extension 24 that extends from the rear wall 26 of the smart case 11. Extension 24 is configured and dimensioned to receive extension arm 104 in its non-extended orientation, and to receive the camera 102 in a top region thereof. A slot 28 may be provided in extension 24 to cooperate with a pin 30 associated with camera assembly 100, thereby enhancing alignment/security of camera assembly 100 relative to extension 24 and facilitating deployment of camera 102 from extension 24 (by sliding pin 30 upward relative to slot 28).

With particular reference to the sectional view of FIG. 15, an exemplary mounting mechanism for securing camera 102 relative to extension arm 104 is depicted. In particular, the distal end of extension arm 104 defines a spherical extension 108 that is configured and dimensioned for receipt in a cooperative hemispheric socket 110 defined at or adjacent the base of camera 102. Cooperative interaction between spherical extension 108 and hemispheric socket 110 define a joint that supports unlimited angular freedom of movement of camera 102. At the opposite end of extension arm 104, a fixed plug 106 functions to secure extension arm relative to smart case 11. Plug 106 is configured and dimensioned to extend into a cavity defined at the proximal end of extension arm 104. Plug 106 is free to pivot relative to smart case 11, thereby providing a further range of motion for camera 102 relative to smart case 11 (and smart phone 12).

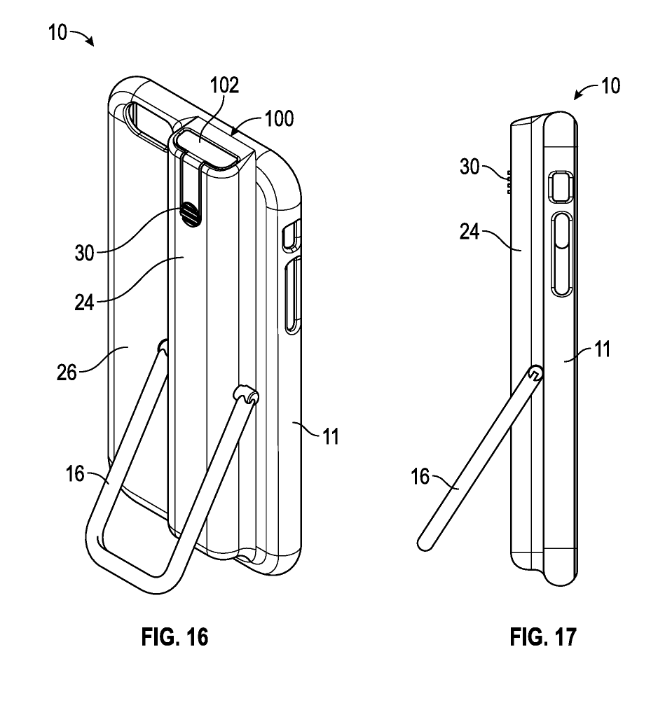

FIGS. 16 and 17 provide views that further illustrate the operation of stand mechanism 16 relative to smart case 11. As noted previously, stand mechanism 16 may be designed so as to support the smart case 11 (and associated smart phone 12) at various angles relative to the vertical axis, e.g., 15°, 20°, 25°, 30°, 35°, 40°, 45°, 50° and angles therebetween. When rotated against the back wall 26 of smart case 11, the stand mechanism 16 may be advantageously extend around the extension 24, thereby minimizing the overall impact of the stand mechanism 16 on the profile to smart case 11.

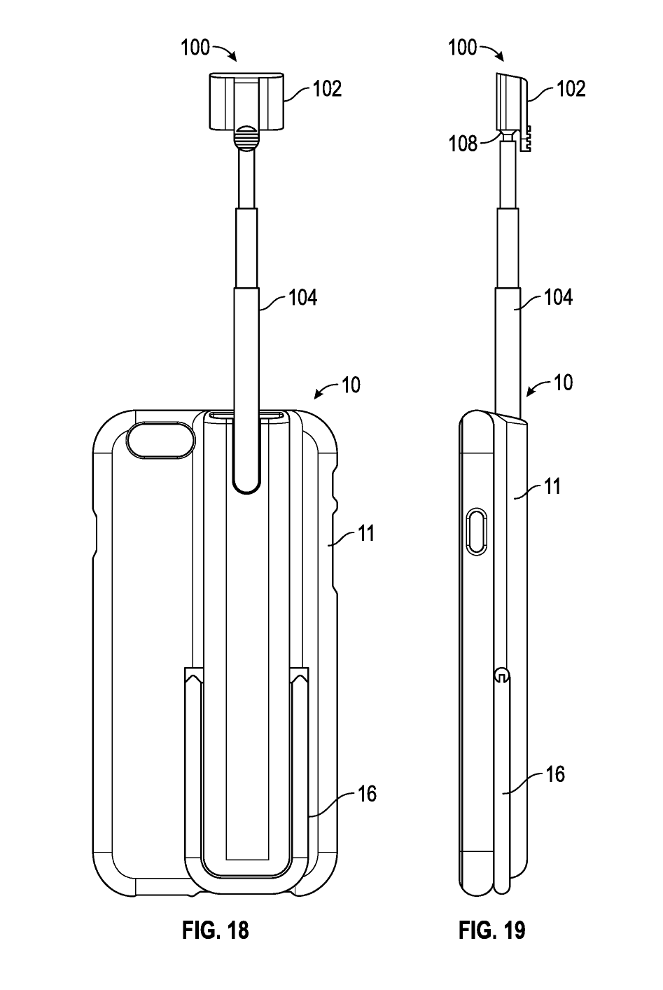

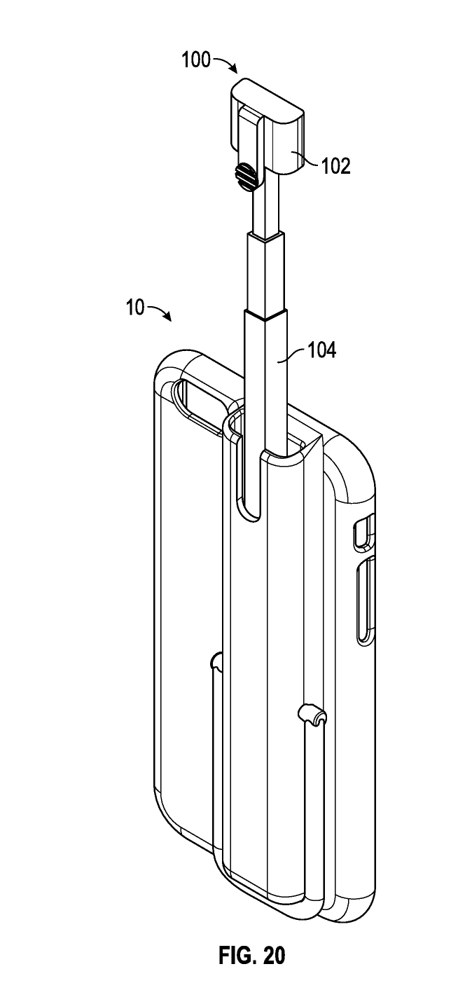

Turning to FIGS. 18-20, the advantageous camera assembly 100 of the present disclosure is depicted with camera 102 in an upward, vertically extended orientation relative to smart case 11. For illustrative purposes, FIGS. 18-20 show extension arm 104 with three telescoping segments to facilitate upward extension of camera 102. However, as will be readily apparent to persons skilled in the art, more or less telescoping segments may be provided and/or employed without departing from the spirit or scope of the present disclosure. Similarly, the cross-sectional profile of extension arm 104 may take various forms, e.g., circular, square, elliptical, rectangular, oval, etc. As is apparent from FIG. 20, the depicted exemplary implementation features a substantially square cross-sectional profile for extension arm 104, but the present disclosure is not limited by or to such exemplary implementation.

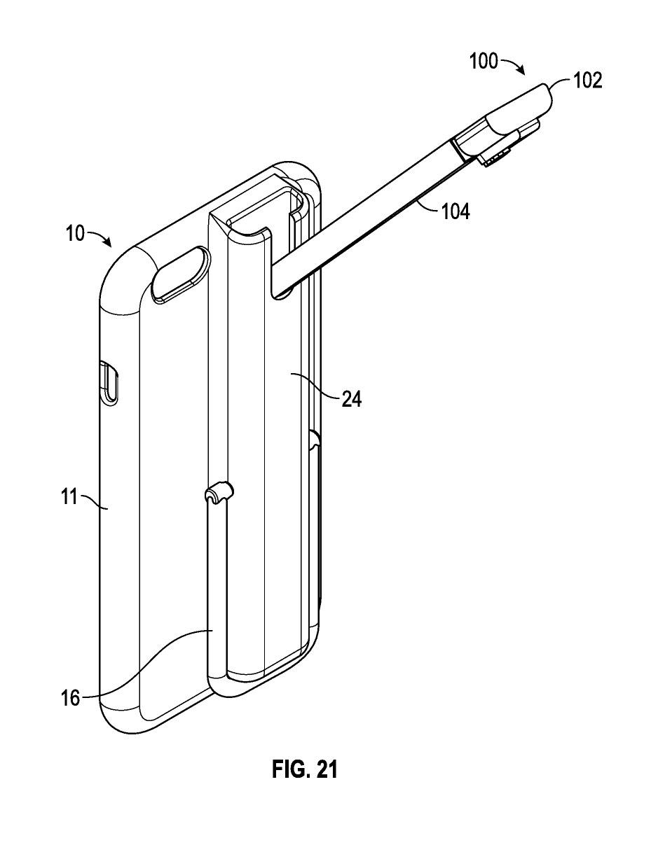

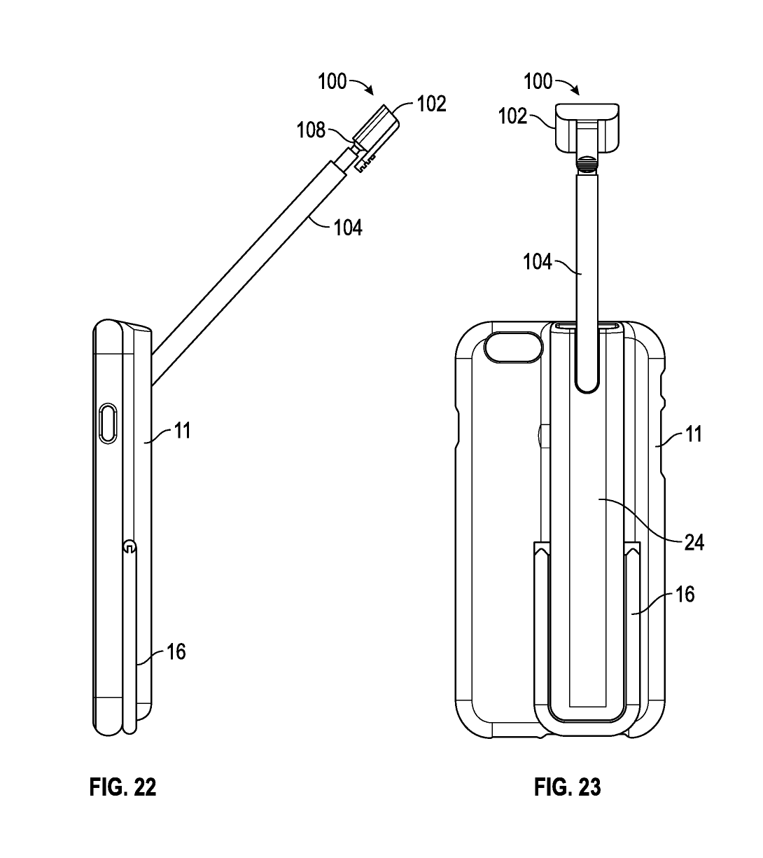

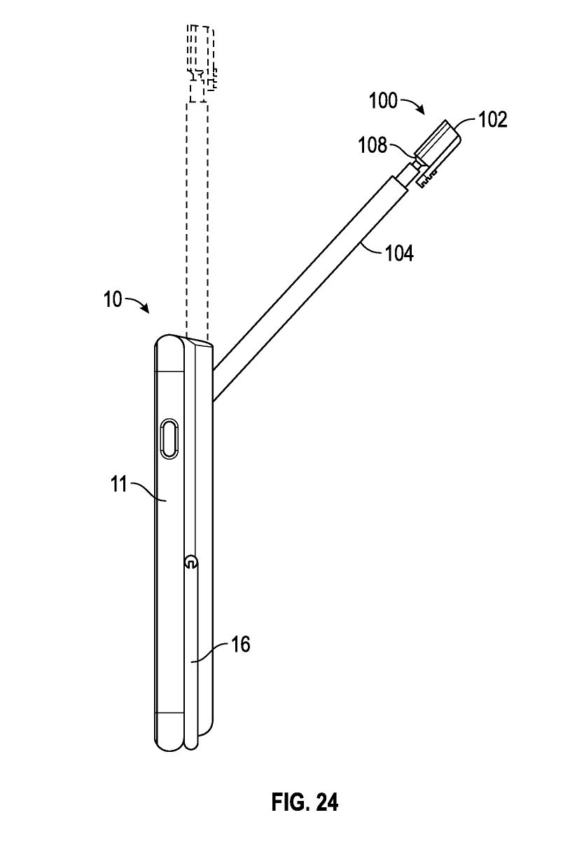

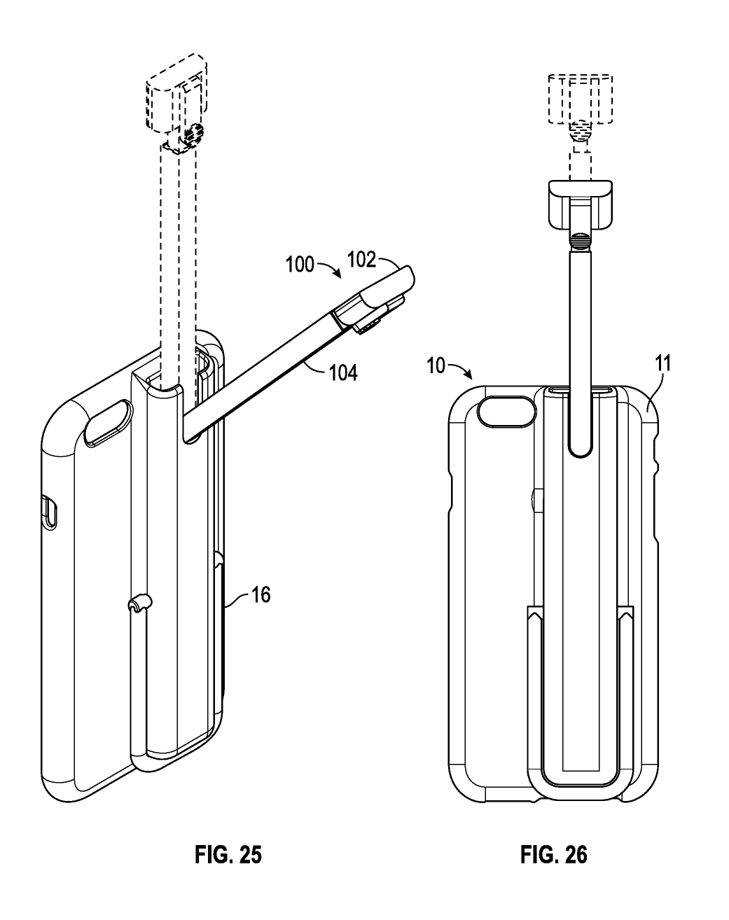

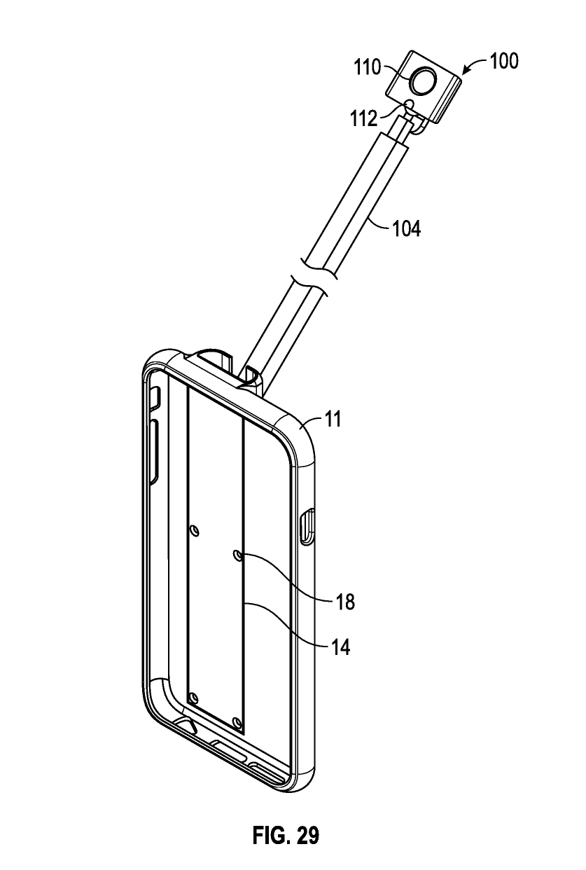

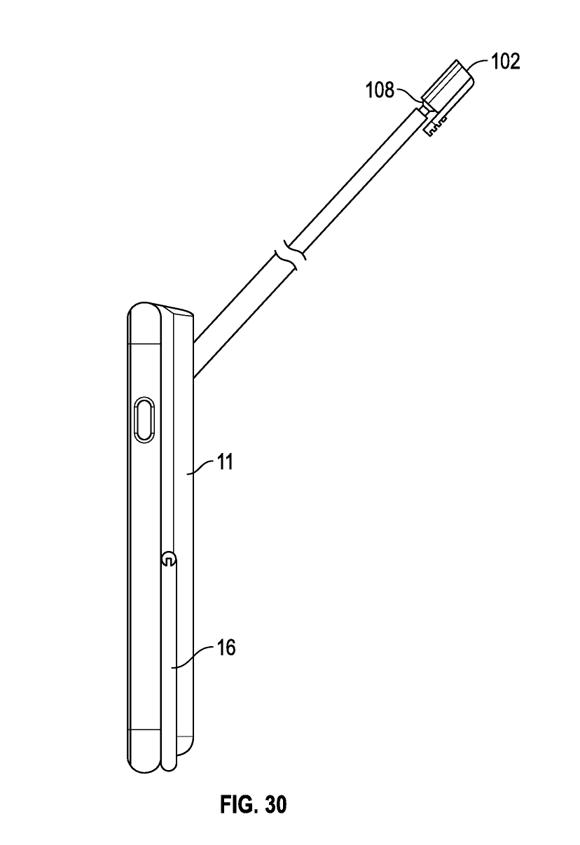

With reference to FIGS. 21-23 and 29-30, the relative orientation of camera 102 has been adjusted (as compared to FIGS. 18-20) by pivoting the extension arm relative to smart case 11. With reference to FIG. 31, the flanges of plug 106 glide along the walls of cavity 22 from the base of smart case 11 to the top. Upon reaching the top of smart case 11, camera assembly 100 can pivot relative to the vertical axis, e.g., 1° to 90° and angles therebetween. Detents at the top of smart case 11, surrounding cavity 22, interface with the flanges of plug 106 to enable camera assembly 100 to rotate without swinging uncontrollably. The relative positioning of camera 102 is further illustrated by the phantom views set forth in FIGS. 24-26.

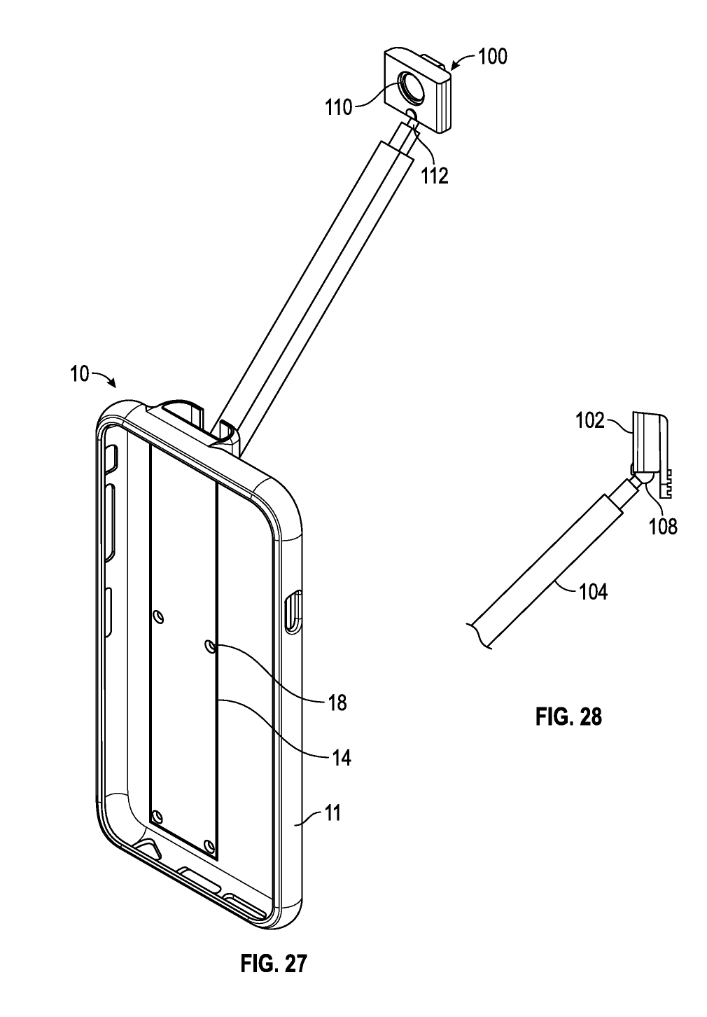

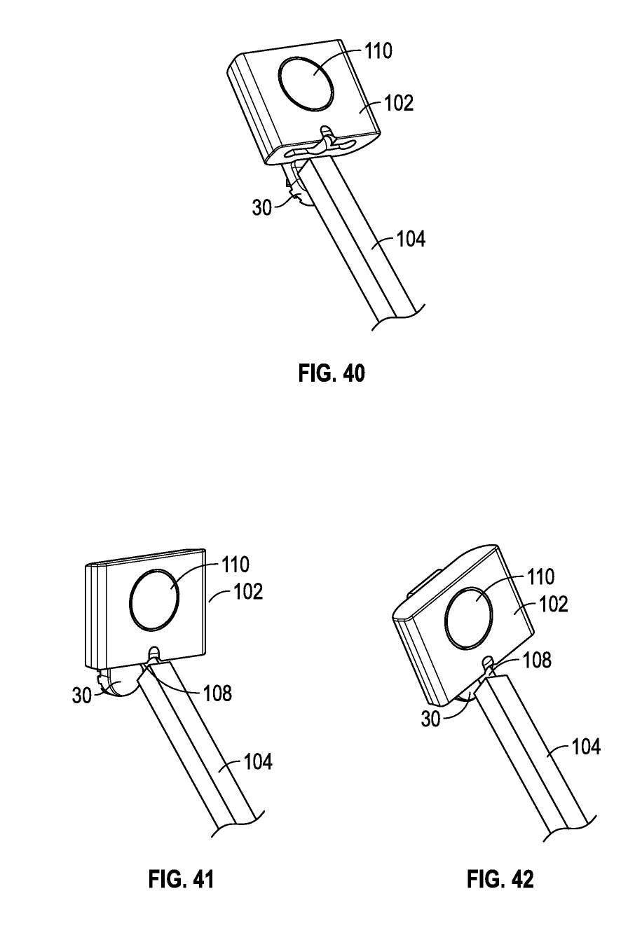

Turning to FIGS. 27-28 and 40-42, the further freedom of movement of camera 102 is illustrated, based on rotation of camera 102 relative to extension arm 104. This further rotational freedom permits the camera 102 to be oriented in the manner desired so as to capture a desired image.

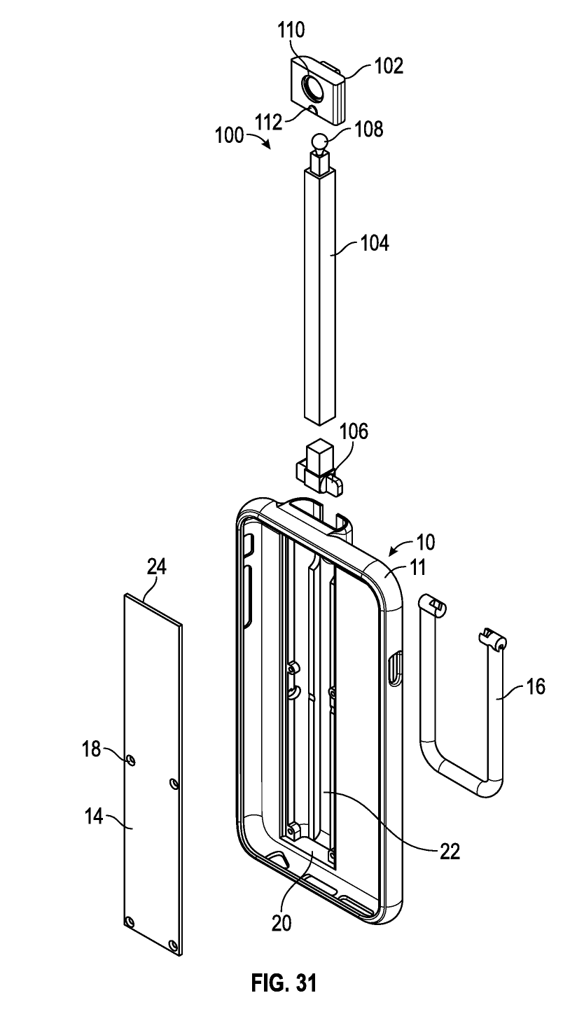

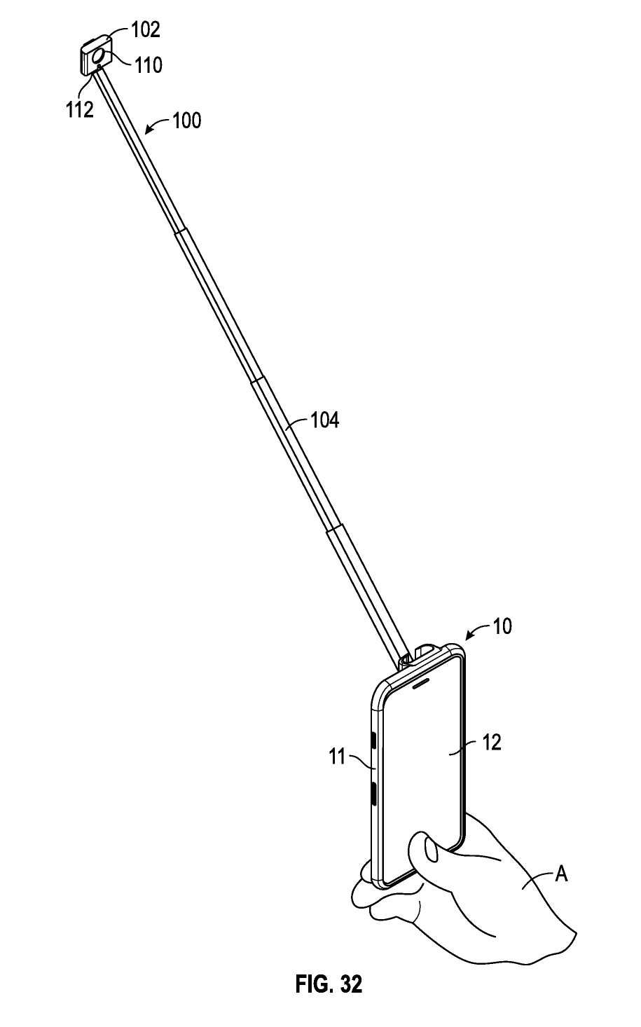

With reference to FIG. 32, the advantageous use of the smart case assembly 10 of the present disclosure is illustrated. Thus, a smart phone user “A” who has associated his/her smartphone 12 with the disclosed smart case 11 is able to extend extension arm 104, pivot extension arm 104 relative to smart case 11, and pivot/rotate camera 102 relative to extension arm, thereby orienting camera 102 to capture an image of the user “A” and potentially colleagues or surrounds associated with user “A” (based on the distance of camera 102 relative to the image to be captured). The user “A” interacts with conventional controls associated with smartphone 12 so as to capture the desired image(s)—whether still image(s) or moving images.

The camera assembly 100 is provided with communication functionality that allows it to communicate the image(s) captured by camera 102 to the processing unit associated with smartphone 12. In exemplary embodiments, camera assembly 100 can communicate with smartphone 12 to transmit and receive information using, e.g., electromagnetic radiation, such as radio frequency communications (i.e. Bluetooth®). As one example, camera assembly 100 can be programmed and/or configured to receive image capturing commands from smartphone 12. As another example, camera assembly 100 can be programmed and/or configured to send the captured images to smartphone 12 in order to process the image (i.e. store, edit and/or delete the image). In this embodiment, camera assembly 100 is outfitted with a power source (not shown).

The power source (not shown) can be implemented as a battery or capacitive elements configured to store an electric charge. In some embodiments, the battery may be replaceable by the user. As another example, in some embodiments, the power source (not shown) can be a rechargeable power source, such as a battery or one or more capacitive elements configured to be recharged via a connection to an external power supply and/or to be recharged by an energy harvesting device.

In another embodiment, camera assembly 100 is electrically connected (i.e. hardwired) to smartphone 12 via the charging port (not shown), wherein camera assembly 100 is powered by the battery (not shown) of smartphone 12. In this same embodiment, camera assembly 100 can receive and send commands and/or images captured via the hardwire connection.

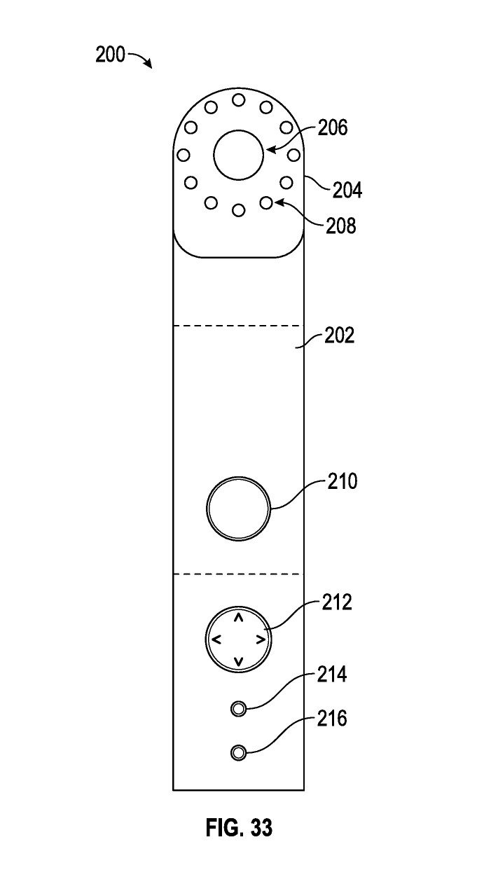

With reference to FIG. 33, much of the functionality associated with the smart case, described above, can be applied to standalone unit 200. Camera 206 is mounted to housing 204, which is attached to body 202 via an extension arm (not shown). Housing 204 can extend, via an extension arm (not shown), and/or pivot/rotate, relative to the buttons on the front face of body 202, so as to facilitate the capture of an image—whether still image(s) or moving images. Light source 208 substantially surrounds camera 206 to provide a flash while capturing an image. Light source 208 can be LED's or another type of bulb, as will be readily apparent to persons skilled in the art. Further, light source 208 can be either manually activated by interfacing with standalone unit 200 or automatically activated based on the lighting in the area where the image will be captured, as will be readily apparent to persons skilled in the art.

With further reference to FIG. 33, an image can be captured by either pressing the button 210 that is centrally located on body 202 or with conventional controls associated with a smartphone. The standalone unit 200 is provided with communication functionality that allows it to communicate the image(s) captured by the camera 206 to the processing unit associated with a smartphone. The communication functionality discussed above further applies to the standalone unit 200. Directional pad 212 may be used to control movement of the camera. Buttons 214 and 216—labeled “pic” and “video” respectively—may be used to select the mode of operation, i.e., “still picture/photograph” mode or “video” mode.

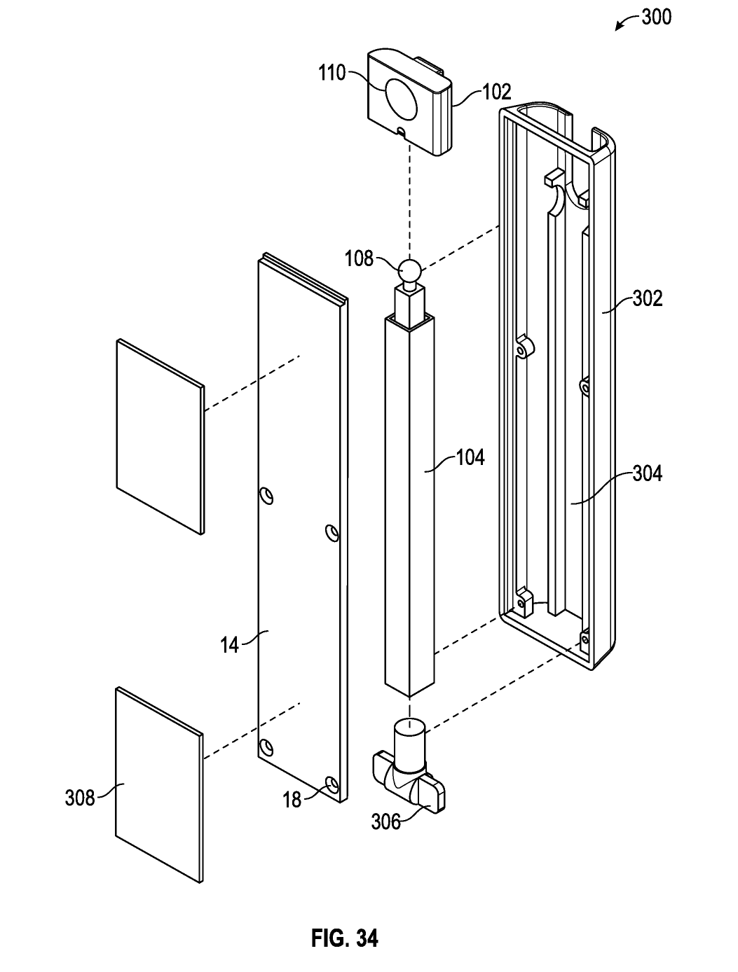

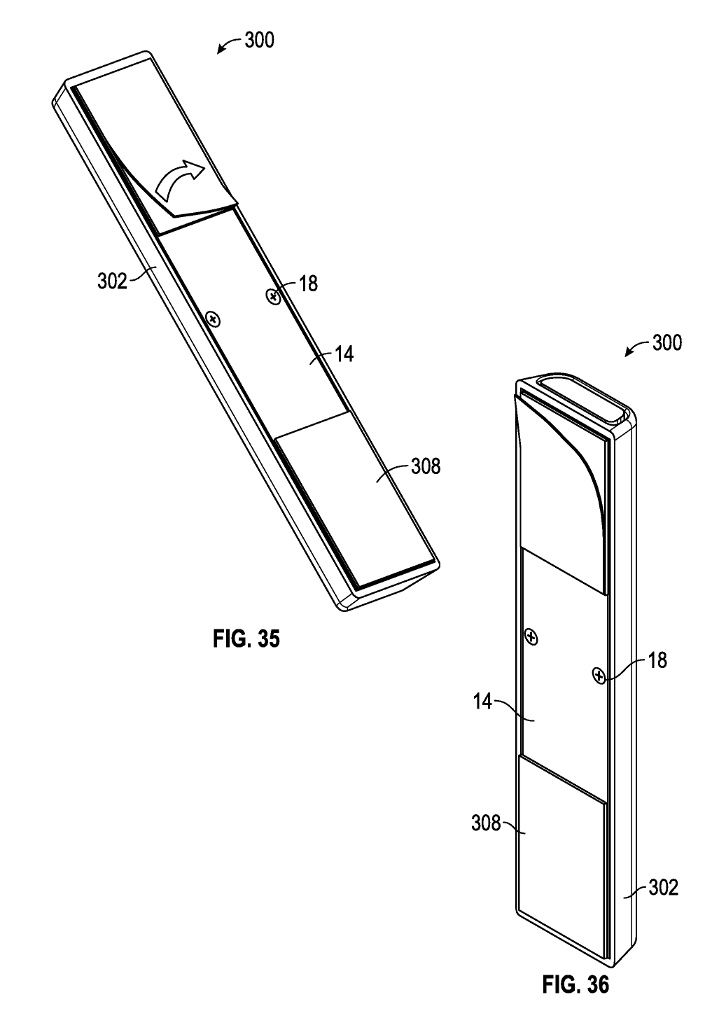

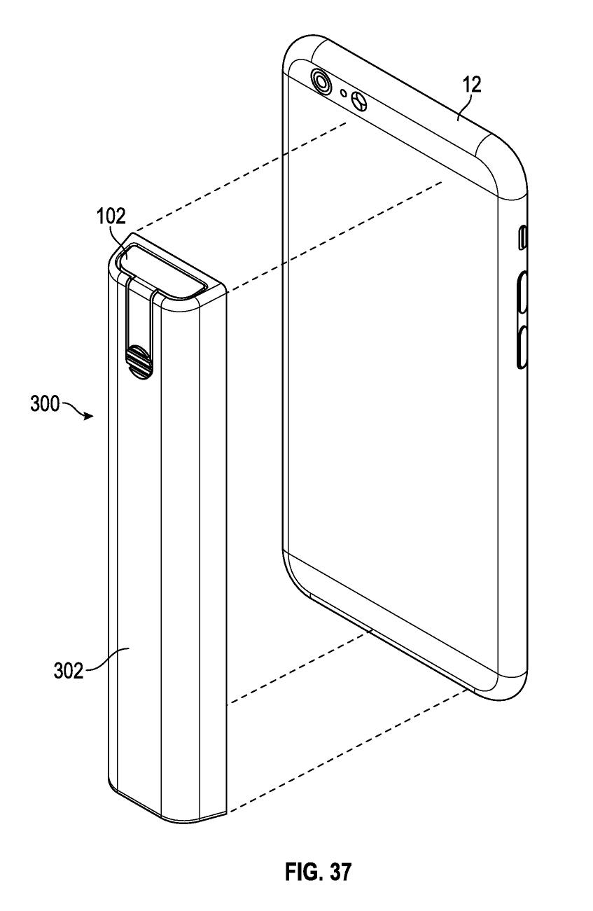

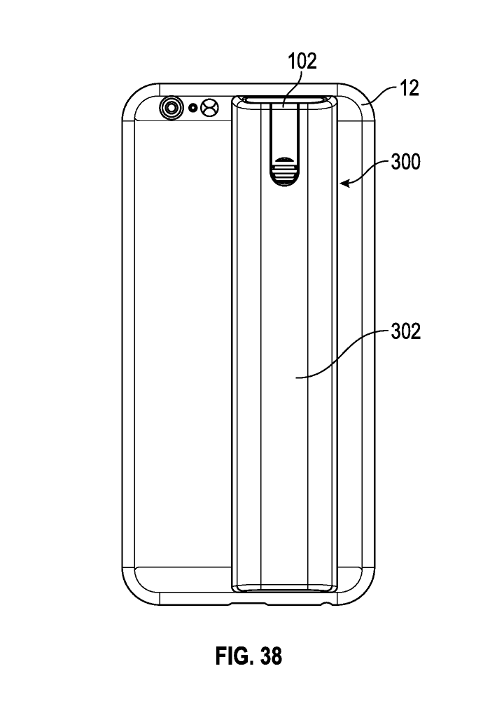

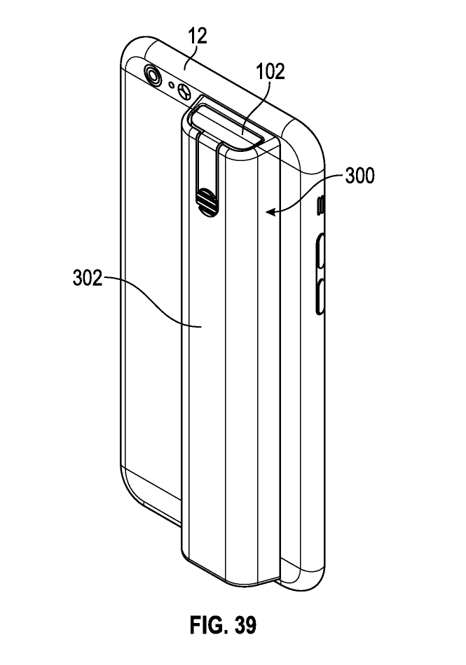

With reference to FIG. 34, assembly 300 is substantially similar to the smart case described above, however, assembly 300 is a separate camera attachment that interfaces directly with smartphone 12. Much like the smart case, extension arm 104 and plug 306 are housed within cavity 304 of attachment housing 302 and enclosed by cover 14. In addition to FIG. 34, FIGS. 35-37 illustrate the interface between smartphone 12 and assembly 300 via pads 308 (i.e., adhesive pads, VELCRO® or the like), as will be readily apparent to persons skilled in the art. Further, FIGS. 38 and 39 illustrate an assembled camera attachment 300 interfaced with a smartphone 12.

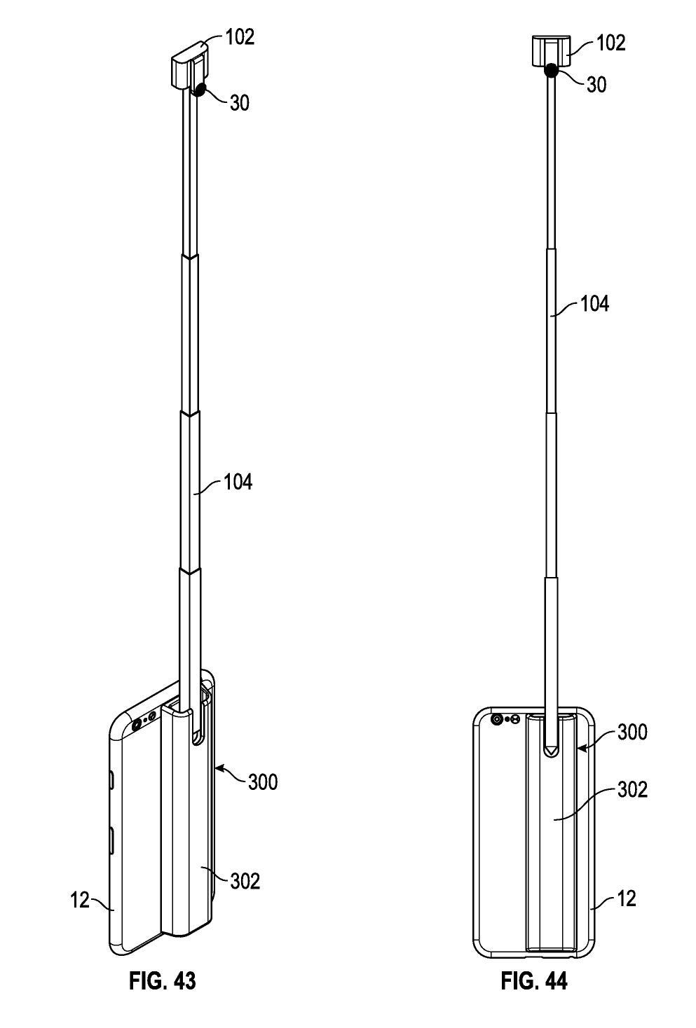

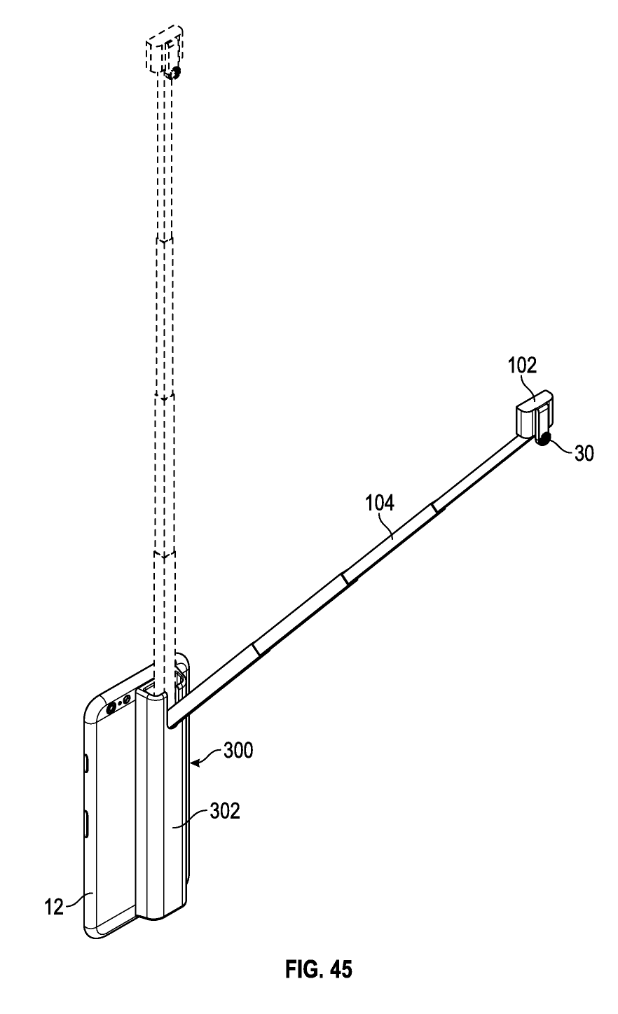

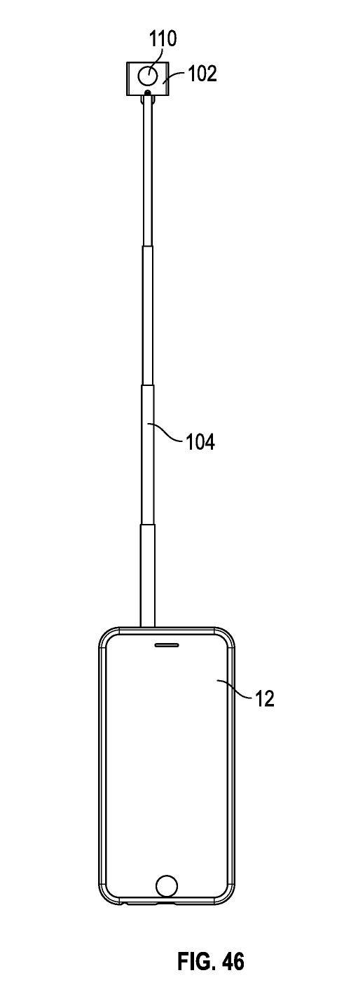

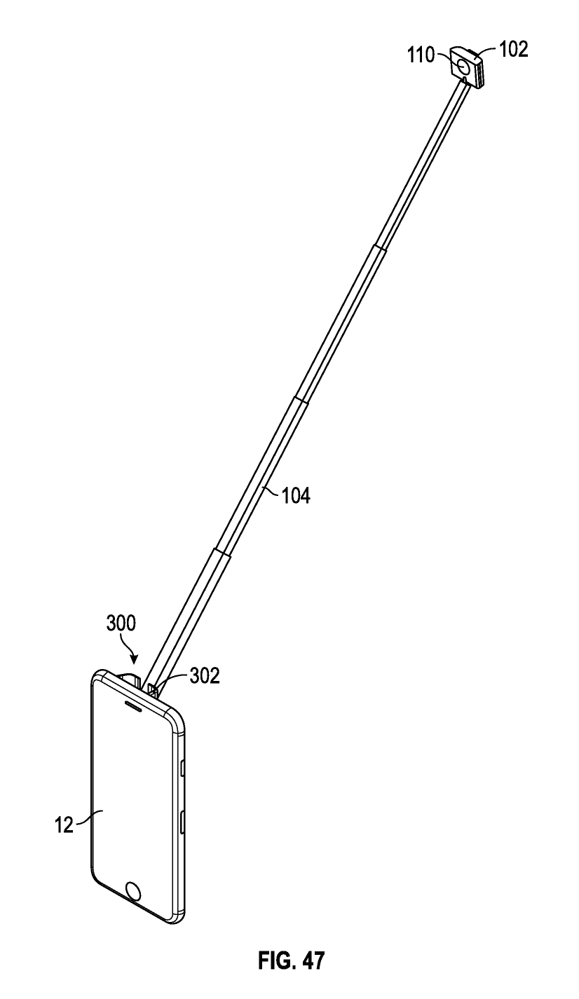

With reference to FIGS. 43 and 44, camera attachment assembly 300 is affixed to the back of smartphone 12 and camera 102 extended vertically via extension arm 104. With reference to FIGS. 45-47, the relative orientation of camera 102 has been adjusted (as compared to FIGS. 43 and 44) by pivoting the extension arm 104 relative to attachment housing 302.

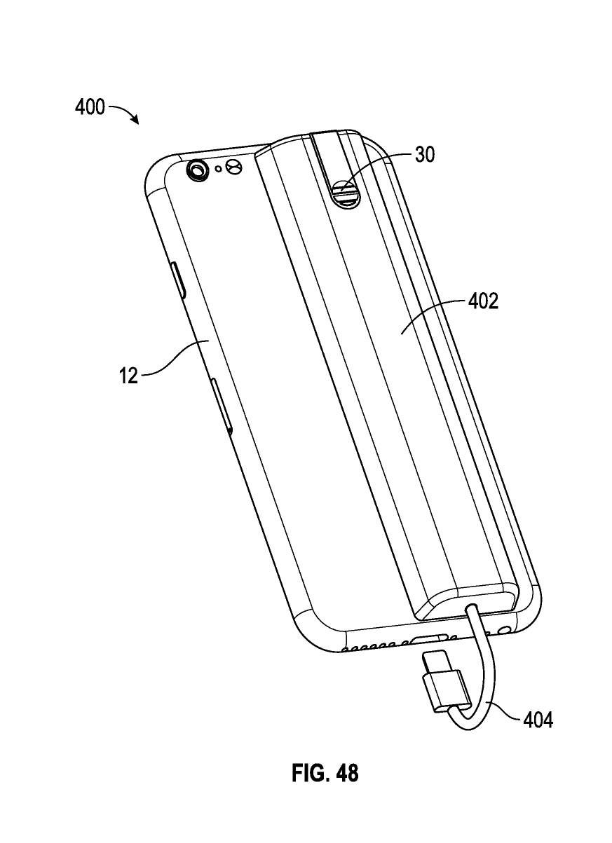

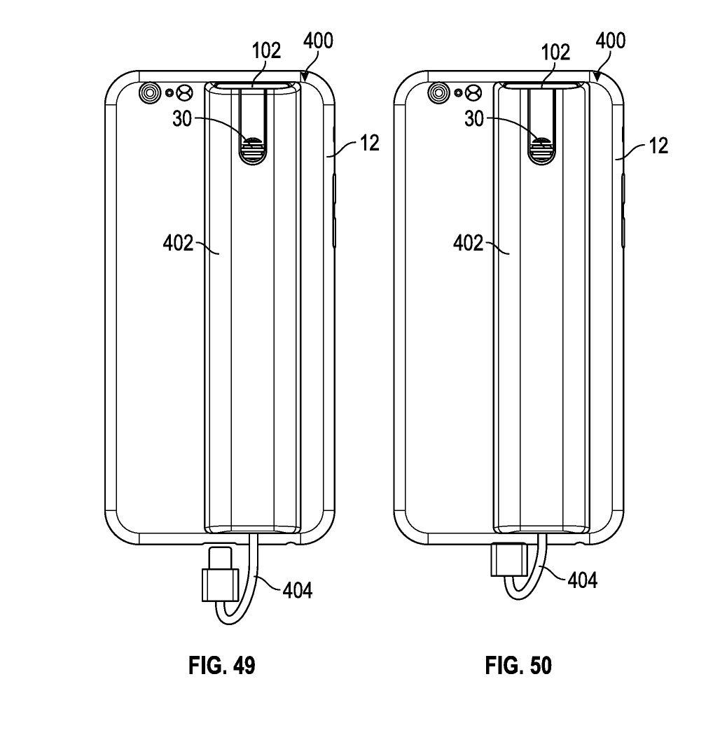

With reference to FIGS. 48-50, camera attachment assembly 400 is affixed to the back of smartphone 12 and is electrically connected via connector 404. Connector 404 inserts directly into the charging port of smartphone 12 and connector 404 enables assembly 400 to receive commands and/or send images and commands to smartphone 12. Further, assembly 400 does not require an additional power source, as described above, assembly 400 can rely on the battery (not shown) of smartphone 12.

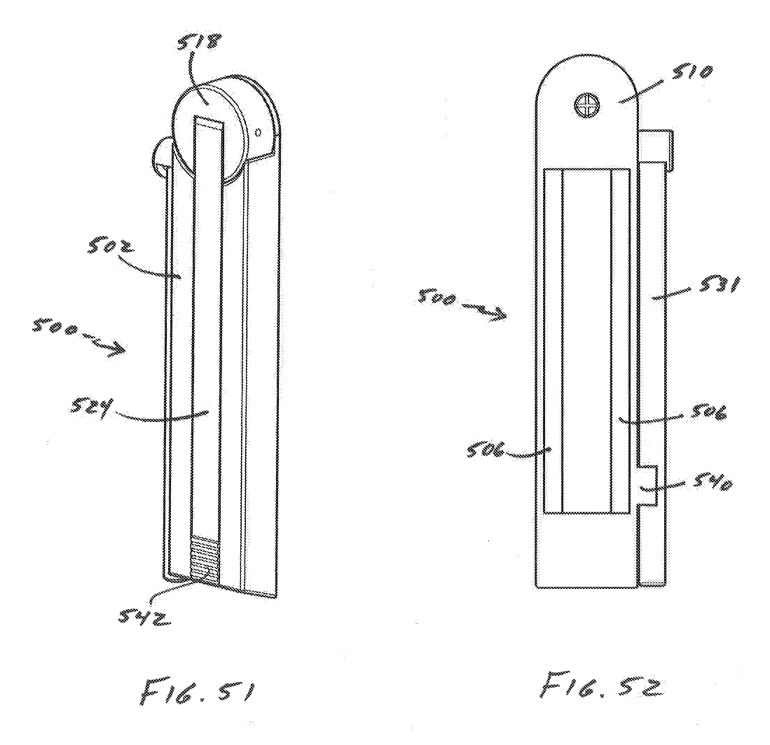

Turning to FIGS. 51-60, an alternative camera accessory 500 is provided according to the present disclosure. With particular reference to the exploded view of FIG. 60, camera accessory 500 includes a housing 502 that defines an opening 504 configured and dimensioned to receive one or more magnets 506. For example, as shown in FIG. 60, camera accessory 500 may be adapted to receive a pair of elongated magnets 506, although the present disclosure is not limited by or to the exemplary magnet implementation depicted in FIG. 60. Indeed, more or fewer magnets may be employed, and the magnet(s) may take alternative geometric form, as will be readily apparent to persons skilled in the art. Magnets 506 advantageously function to detachably secure camera accessory 500 relative to an electronic device, e.g., a smartphone, tablet or other electronic device.

A metallic plate 508 is generally provided for use in conjunction with camera accessory 500. The plate 508 is generally sized to fit within opening 504. Two-sided tape (or other adhering material) is advantageously applied to one side of plate 508, and plate 508 is adapted to be applied to the back face of a smartphone or other electronic device using the exposed side of the two-sided tape (or other adhering material) to adhere plate 508 thereto. When camera accessory 500 is to be mounted with respect to a smartphone or other electronic device, magnetic attraction between magnets 506 and plate 508 function to secure camera accessory 500 with respect to the smartphone/electronic device. Indeed, the sizing of plate 508 relative to opening 504 advantageously functions to center/position camera accessory 500 in a desired manner relative to the smartphone/electronic device. When the camera accessory 500 is not secured relative to the smartphone/electronic device (e.g., temporarily secured to a metallic surface such as a refrigerator or the like), the planar geometry of plate 508 makes in a non-obstructive aspect of the backface of the smartphone/electronic device.

With further reference to FIG. 60, housing 502 defines an upward extension tab 510 that defines a semicircular/arcuate edge 512. An aperture 514 is defined in extension tab 510 which is configured/dimensioned to receive an axle element 516 that is associated with a rotatable dial 518. Axle element 516 may be defined by dial 518 (i.e., integral therewith) or may be received by dial 518. In either case, cooperation between axle element 516 and aperture 514 permits rotation of rotatable dial 518 relative to extension tab 510 and, more generally, relative to housing 502.

More particularly, rotatable dial 518 defines a cylindrical outer face 520 that defines an opening 522 that is configured/dimensioned to cooperate with a telescoping extension 524 which is mounted relative to dial 518. In the absence of telescoping extension 524, dial 518 would be free to rotate 360° relative to extension tab 510. However, once telescoping extension 524 is mounted with respect to dial 518—e.g., by a pin (not pictured) that extends thru openings 523 formed in the outer face 520 of dial 510—rotation of dial 518 relative to extension tab 510 is limited to less than 360°. In exemplary embodiments of the present disclosure, rotation of dial 518 relative to extension tab 510 is at least 180°, but is limited to about 320°, and in further embodiments rotation is limited to about 300°. The rotatable dial 518 permits the camera 528 and associated telescoping elements—as described below—to rotate at least from a first axial alignment with the axis of housing 502 to a second axial alignment with the axis of housing 502, but that is rotated 180° relative to the first axial alignment. The exact rotational extent of dial 518 relative to extension tab 510 may vary, but the degree of rotation permits at least 180° of rotation and is generally limited by the overall design/structure of accessory 500 such that rotation of 360° is not permitted.

Telescoping extension 524 generally cooperates with one or more telescoping extension elements 526 that are nested within each other so as to permit axial extension thereof. At an end of the inner-most telescoping extension element 526 is mounted a camera 528. The mounting mechanism for joining camera 528 to extension element 526 may take various forms. In the exemplary embodiment schematically depicted in FIG. 60, extension element 526 defines a ball-like structure 530 at a distal end thereof. The ball-like structure 530 is configured/dimensioned to be received in a corresponding cup-like cavity formed in camera 528, thereby providing a ball joint that permits the orientation of camera 528 to be adjusted relative to extension element 526. Adjustment is generally accomplished manually, e.g., by grasping camera 528 and reorienting it relative to extension element 526. Camera 528 may include one or more detachable lenses that may be interchangeably associated therewith. For example, lenses with different focal points and/or different ranges of view (e.g., wide angle) may be interchangeably secured to camera 528.

The extension elements 526 may advantageously remain in electronic communication as they are sequentially deployed from an initial nested configuration. For example, internal communication brushes and/or other internal electronic contacts may be associated with the extension elements 526 to ensure continuous electronic communication therebetween. In this way, power may be communicated from within housing 502 to camera 528, thereby facilitating control and actuation thereof.

The cross-sectional geometries of telescoping extension 524 and/or extension element(s) 526 may take various forms. For example, the cross-sectional geometries may be circular, oval, elliptical, triangular, rectangular, trapezoidal and variations thereof. The cross-sectional geometry is generally effective to provide desired structural integrity to the telescoping extension mechanism when deployed. For example, individual components of the telescoping extension mechanism may be approximately four inches (4″) in length. If four (4) extension elements 526 are nested within telescoping extension 524 then, when fully deployed, the telescoping extension mechanism may extend approximately twenty inches (20″) from rotatable dial 518 (based on the length of the telescoping extension 524 and the four extension elements positioned therewithin). Longer and shorter extensions may be accommodated by the present disclosure, as will be readily apparent to persons skilled in the art.

Exemplary embodiments of the disclosed accessory 500 also include a pivotal kickstand 531 that is mounted relative to housing 502. As shown in the exploded view of FIG. 60, kickstand 531 may define a mounting barrel 532 at an upper extent thereof. The mounting barrel 532 may be configured/dimensioned to be received in a mounting channel 534 that extends from a side face 536 of housing 502. A pin (not pictured) may be received by apertures formed in the mounting barrel 532 and mounting channel 534 to facilitate rotational/pivotal motion of kickstand 531 relative to housing 502. Kickstand 531 defines a securing slot 538 toward the bottom thereof that engages with a latching arm 540 that extends relative to side face 536 of housing 502. Latching arm 540 generally engages with securing slot 538 to detachably retain kickstand 531 in its non-deployed position unless/until the user chooses to pivot/rotate kickstand 531 away from housing 502.

With reference to FIGS. 51-59, various aspects of the use and operation of accessory 500 are schematically depicted. Thus, as shown in FIGS. 51-57, exemplary elements of accessory 500 are depicted with the camera 528 and kickstand 531 in their non-deployed orientations. As shown in several of the figures (e.g., FIGS. 51, 54, 58 and 59), the rear face of camera 528 include a knurled region 542 in proximity to facilitate user interaction therewith. As shown in FIG. 54, telescoping extension 524 may also define a tee-region 544 adjacent the knurled region 542. The tee-region 544 may advantageously facilitate positioning of the camera 528 and telescoping extension 524 relative to housing 502 when rotated into its non-deployed configuration.

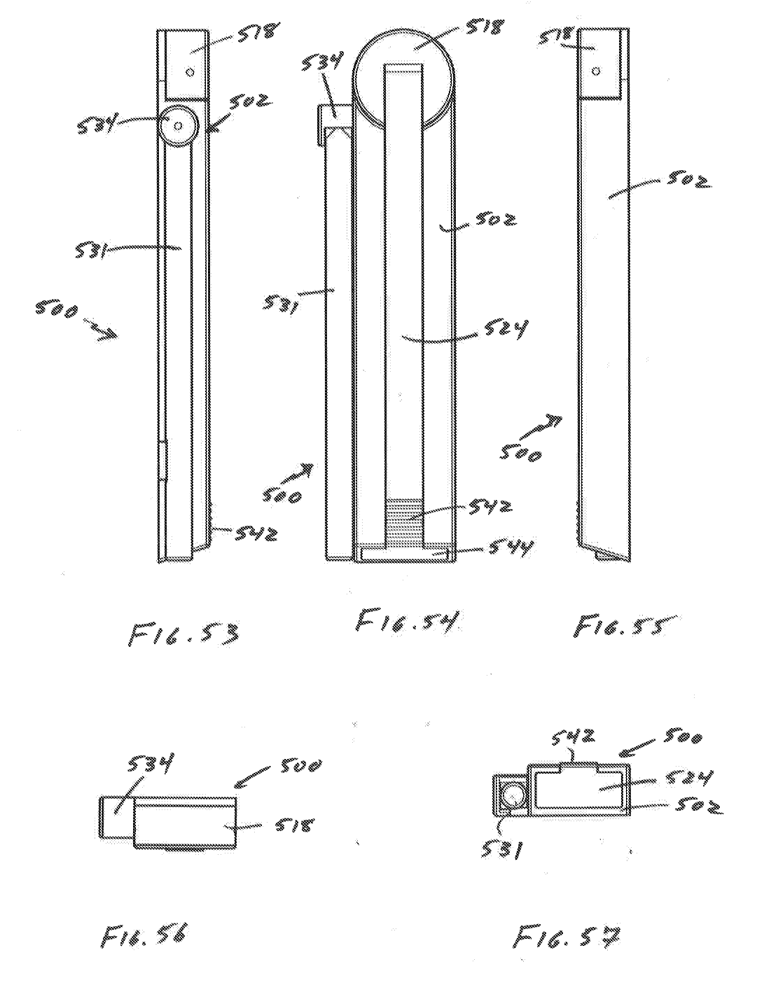

With particular reference to the cross-section of FIG. 59, it is noted that the lens 529 of camera 528 is generally protected by facing into housing 502 when in its non-deployed configuration.

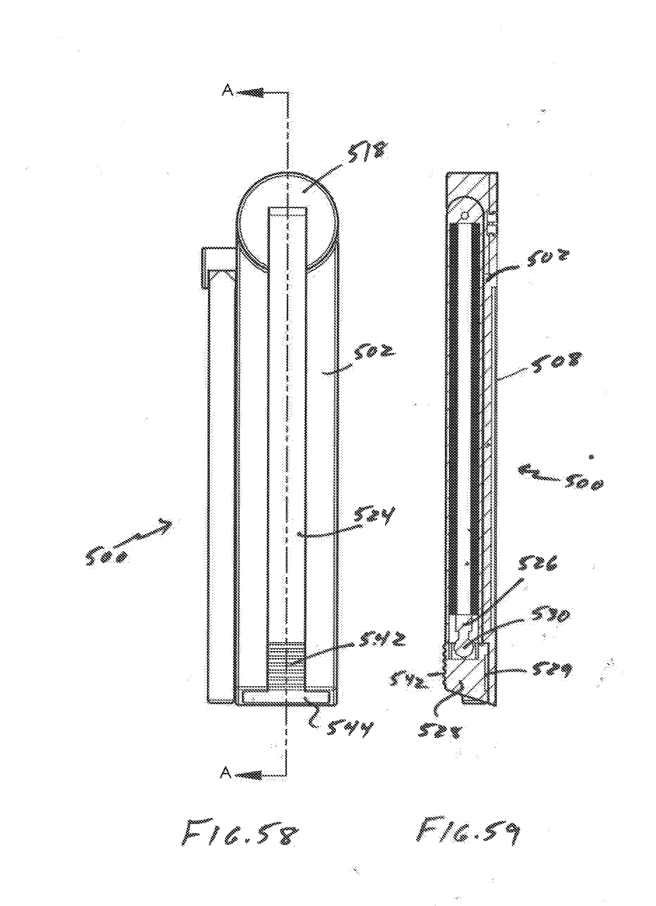

Turning to FIGS. 61-63, various aspects of the deployment, operation and use of camera accessory 500 in conjunction with an electronic device, e.g., a smartphone, are schematically depicted. However, as noted above, use of the disclosed camera accessory is not limited to deployment in conjunction with a smartphone. To the contrary, the disclosed camera accessory may be used in conjunction with various electronic devices, including specifically tablets and other electronic devices that include, inter alia, camera-related functionalities.

In particular, with reference to FIGS. 61-70, camera accessory 500 is mounted with respect to a rear face of a smartphone 600. As noted above, the mounting of camera accessory 500 relative to smartphone 600 may be achieved by way of internally positioned magnets 506 interacting with plate 508 which is adhered to the back face of smartphone 600, or alternative (or complementary) mounting mechanisms. For example, two-way tape may be applied to plate 508, facilitating adherence between plate 508 and smartphone 600. Thereafter, magnetic interaction between magnets 506 (mounted within camera accessory 500) and plate 508 serves to mount camera accessory relative to smartphone 600. Alternative mounting mechanisms may be employed, as will be apparent to persons skilled in the art.

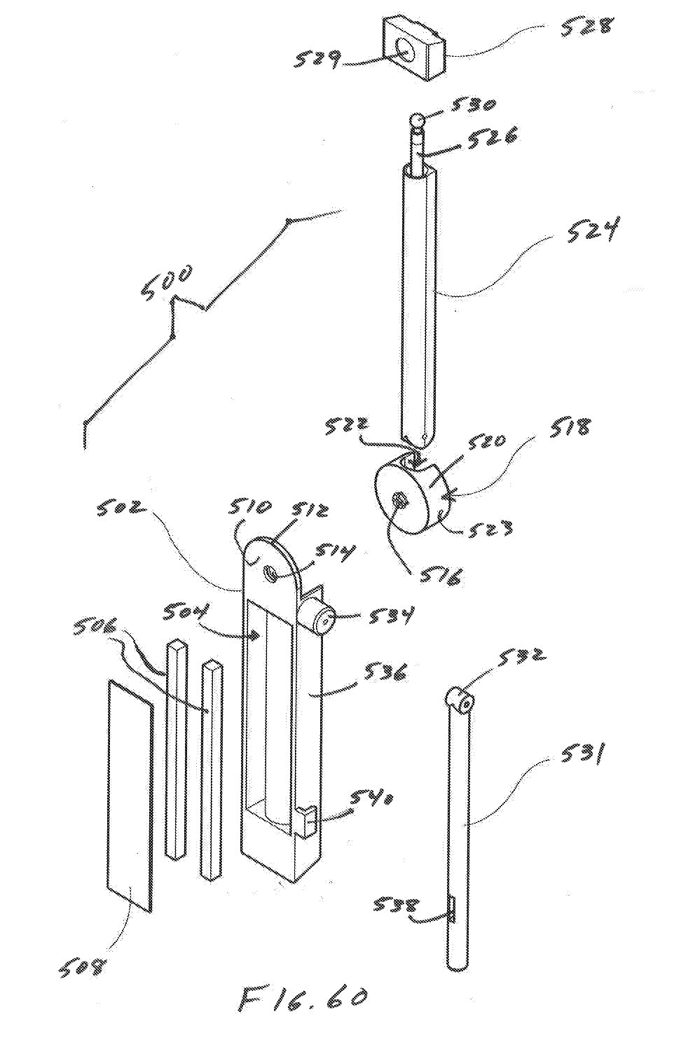

With particular reference to FIGS. 61 and 62, an exemplary smartphone 600 and camera accessory 500 combination are schematically depicted with kickstand 531 angularly deployed. The angular deployment of kickstand 531 may vary and may be controlled, for example, through an internal detent mechanism or the like. In addition, a stop may be defined by mounting channel 534 to control angular deployment, e.g., at nor more than 30°, 45° or the like.

Turning to FIG. 63, an exemplary smartphone 600 and camera accessory 500 combination are schematically depicted with camera 528 extended by a distance supported by telescoping extension 524 and four (4) extension elements 526 (526a, 526b, 526c, 526d). The present application is not limited by or to embodiments that include four extension elements 526. To the contrary, more or less extension elements 526 may be included without departing from the spirit or scope of the present disclosure. Of note, the telescoping extension 524 is angled away from the smartphone 600 in the exemplary embodiment depicted in FIG. 63, although the present disclosure is not limited by or to designs that permit such outward angling of the telescoping extension mechanism.

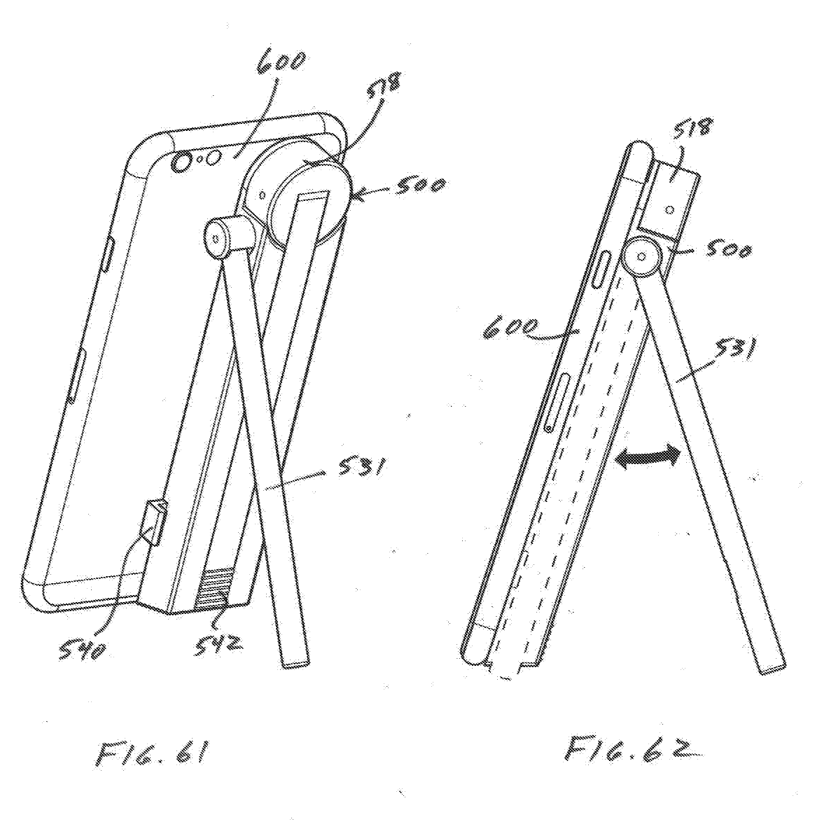

When deployed in the manner depicted in FIG. 63, the camera 528 may be actuated by interacting with an actuating feature associated with smartphone 600, as is known in the art. Communication between smartphone 600 and camera accessory 500 may be based on a wired connection therebetween (as shown in FIGS. 64-66) or by a wireless communication protocol, e.g., Bluetooth or the like. To the extent wireless communication protocols are contemplated, the disclosed camera accessory 500 is provided with conventional communication components to support such wireless communications, as are known to persons skilled in the art.

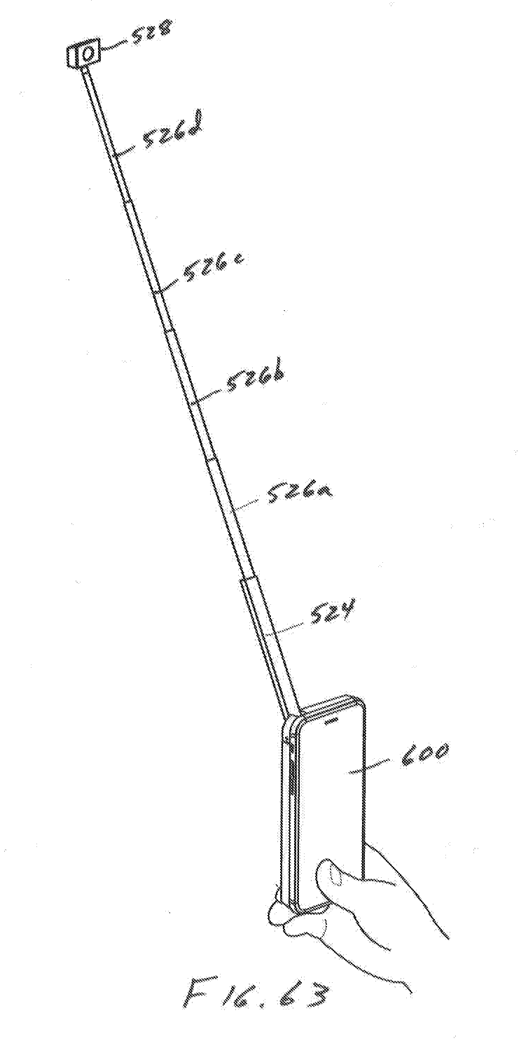

With reference to FIGS. 64-66, a coupling mechanism 550 is provided that allows camera accessory 500 to electronically communicate with smartphone 600. As shown in the sequence of FIGS. 64-66, coupling mechanism 550 is initially housed within camera accessory 500 (FIG. 64), but is adapted to be extended from camera accessory 500 (FIG. 65), aligned with a coupling jack associated with smartphone 600 and introduced thereto (FIG. 66). Once coupled, smartphone 600 may supply power and/or electronic commands to camera accessory 500 (e.g., actuation of camera 528, focusing of camera 528, and the like), and camera accessory 500 may supply data/files/images to smartphone 600 and/or draw power from smartphone 600. As is readily apparent, coupling mechanism 500 may also be coupled to alternative device(s), e.g., power sources, alternative electronic devices, and the like, that are independent of smartphone 600.

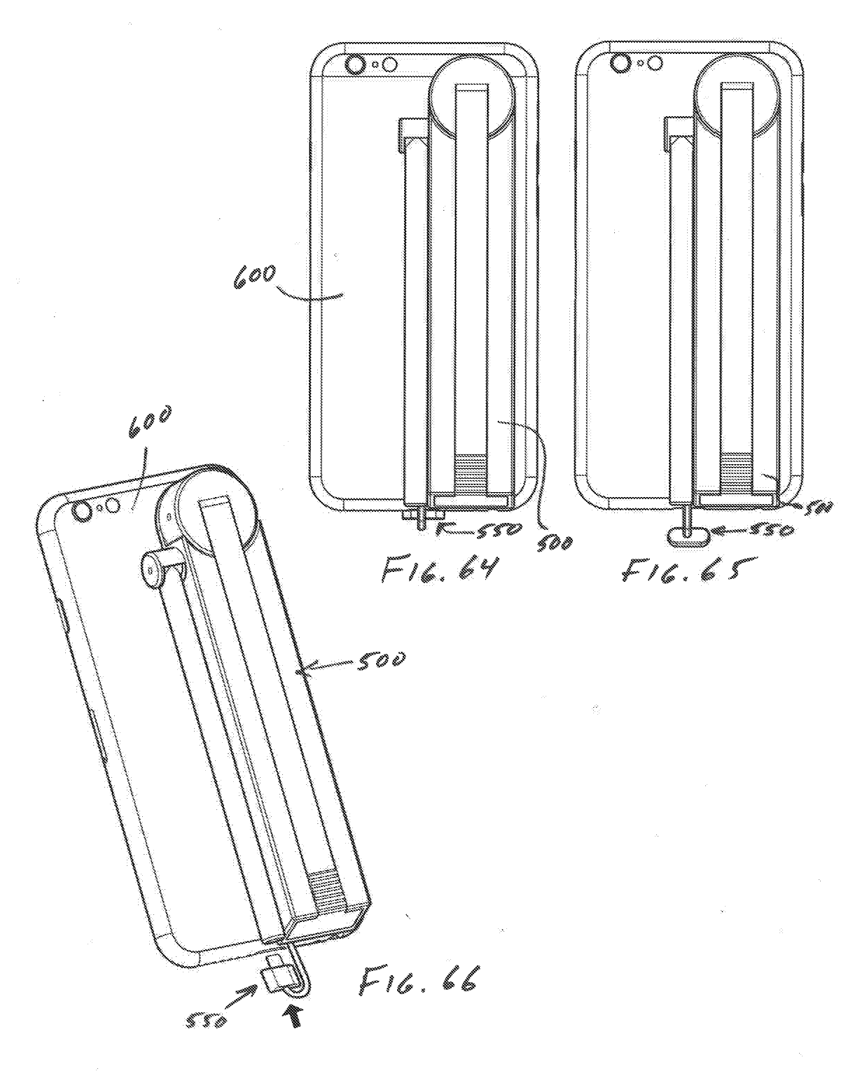

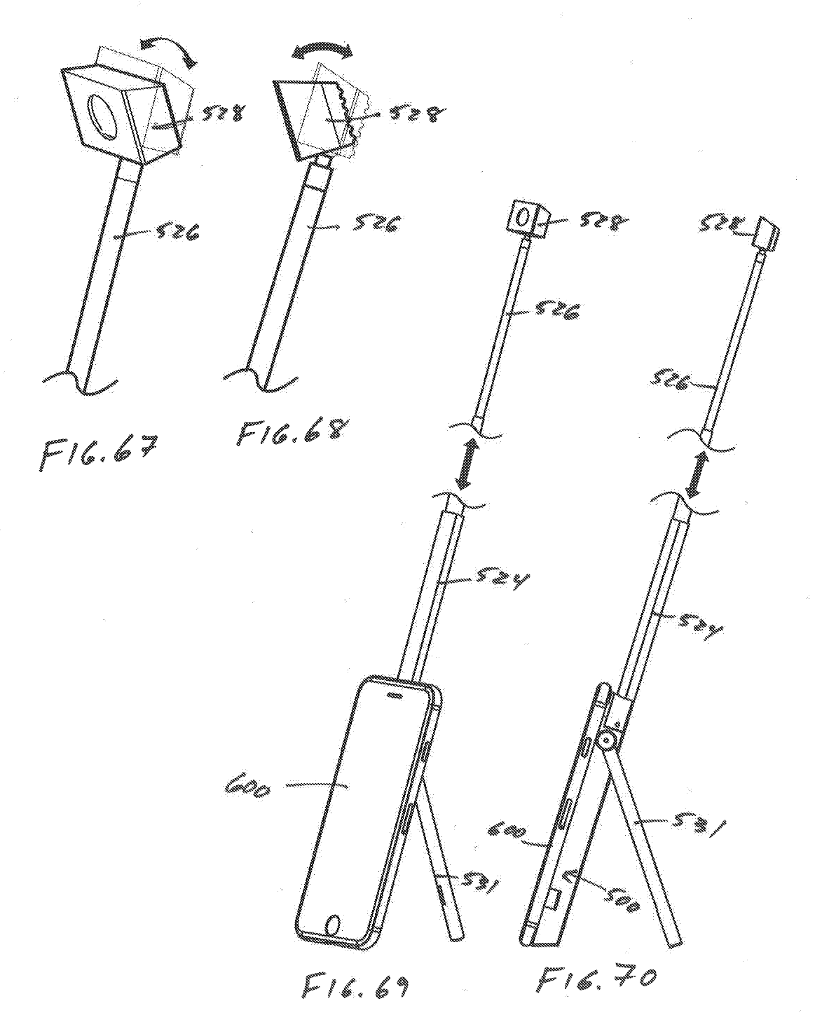

With reference to FIGS. 67-70, perspective views (FIGS. 67, 69) and side views (FIGS. 68, 70) are provided showing the flexibility in positioning of the camera 528 relative to camera accessory 500 and smartphone 600. In particular, FIGS. 67 and 68 schematically depict repositioning/reorientation of camera 528 based on the ball joint (or other mechanism) that joins camera 528 to extension element 526. FIGS. 69 and 70 schematically depict the telescoping functionality associated with nested extension elements 526 and/or telescoping extension 524. As shown in FIGS. 69 and 70, the telescoping functionality may be implemented with smartphone 600 supported by kickstand 531, although the present disclosure is not limited by or to such implementation.

Although the present disclosure has been described with reference to exemplary embodiments and implementations thereof, the present disclosure is not limited by or to such exemplary embodiments/implementations. Rather, the devices, systems and methods disclosed herein may be modified, enhanced and/or refined without departing from the spirit or scope of the present disclosure.

1. An accessory device for use with an electronic device, comprising:
a. a housing that defines a housing axis and that is configured and dimensioned to be mounted with respect to the electronic device;
b. a rotatable dial rotatably mounted with respect to the housing;
c. a telescoping extension arm that defines an extension arm axis and that is mounted with respect to the rotatable dial; and
d. a camera mounted with respect to a distal end of the telescoping extension arm;
wherein the rotatable dial permits the extension arm axis of the telescoping extension arm to rotate at least 180° relative to the housing axis; and
wherein the camera is adapted for electronic communication with the electronic device to deliver one or more images captured by the camera to the electronic device.

2. The accessory device according to claim 1, wherein the housing is detachably mounted with respect to the electronic device.

3. The accessory device according to claim 2, further comprising one or more magnetic elements positioned within the housing, and wherein the one or more magnetic elements function to detachably mount the housing with respect to the electronic device.

4. The accessory device according to claim 3, further comprising a metallic plate that is adhered to a face of the electronic device, and wherein the one or more magnetic elements engage the metallic plate to detachably mount the housing with respect to the electronic device.

5. The accessory device according to claim 4, wherein the housing defines an opening in proximity to the one or more magnets, and wherein the metallic plate is configured and dimensioned to interact with the opening to position the housing relative to the electronic device.

6. The accessory device according to claim 4, wherein the metallic plate is adhered to the face of the electronic device with two-sided tape.

7. The accessory device according to claim 1, further comprising a kickstand pivotally or rotatably mounted with respect to the housing.

8. The accessory device according to claim 1, wherein the camera is mounted with respect to the distal end of the extension arm by way of a swivel joint.

9. The accessory device according to claim 1, wherein the camera may be angularly repositioned relative to the extension arm relative to both the x-axis and the y-axis.

10. The accessory device according to claim 1, further comprising means for communication adapted to receive commands from the electronic device and communicate images from the camera to the electronic device.

11. The accessory device according to claim 1, wherein the telescoping extension arm includes a telescoping extension and one or more nested telescoping extensions.

12. The accessory device according to claim 1, wherein the rotatable dial is mounted with respect to an upward extension tab defined by the housing.

13. In combination,
a. an electronic device; and
b. an accessory device detachably mounted with respect to the electronic device, the accessory device comprising:
i. a housing that defines a housing axis and that is configured and dimensioned to be mounted with respect to the electronic device;
ii. a rotatable dial rotatably mounted with respect to the housing;
iii. a telescoping extension arm that defines an extension arm axis and that is mounted with respect to the rotatable dial; and
iv. a camera mounted with respect to a distal end of the telescoping extension arm;
wherein the rotatable dial permits the extension arm axis of the telescoping extension arm to rotate at least 180° relative to the housing axis; and
wherein the camera is adapted for electronic communication with the electronic device to deliver one or more images captured by the camera to the electronic device.

14. The combination of claim 13, wherein the electronic device is a smartphone or tablet.

15. The combination of claim 13, wherein the electronic device communicates with the accessory device by a wired connection.

16. The combination of claim 13, wherein the electronic device wirelessly communicates with the accessory device.

17. The combination of claim 13, wherein the electronic device is used to actuate the camera of the accessory device.

18. The combination of claim 13, wherein the housing of the accessory device contains one or more magnets that function to detachably mount the accessory device relative to the electronic device.

19. The combination according to claim 18, further comprising a metallic plate adhered to a face of the electronic device, wherein the housing of the accessory device defines an opening in proximity to the one or more magnets, and wherein the metallic plate to magnetically engage the one or more magnets and functions to interact with the opening to position the housing of the accessory device relative to the electronic device.

20. The combination of claim 13, wherein the accessory device further comprises a kickstand that is pivotally or rotatably mounted with respect to the housing.
